(19) United States
(12) Patent Application Publication
(10) Pub. No.: US 2015/0275422 A1
(43) Pub. Date: Oct. 1, 2015

(54) Continuous Non-slip Layered Garment

(71) Applicant: James Paul Cherneski, Bel Air, MD (US)

(72) Inventor: James Paul Cherneski, Bel Air, MD (US)

(21) Appl. No.: 14/670,855

(22) Filed: Mar. 27, 2015

Related U.S. Application Data
(60) Provisional application No. 61/971,613, filed on Mar. 28, 2014.

(51) Int. Cl. D06N 3/00; D04B 1/24; B32B 27/12; B32B 5/02; B32B 25/10

(52) U.S. Cl. CPC D06N 3/0009; D06N 3/0015; B32B 5/026; B32B 25/10; B32B 27/12; D04B 1/24; D10B 2501/00; B32B 2250/03; B32B 2307/744; B32B 2437/02; D10B 2403/01

(57) ABSTRACT

A method for making a continuous non-slip layered garment includes creating a fabric structure having inner and outer surfaces, which conforms to a body part, and creating continuous non-slip layers on the inner and outer surfaces of the fabric structure. The inner surface is proximal to a user contact surface and distal to an external contact surface. The outer surface is proximal to the external contact surface and distal to the user contact surface. The continuous non-slip layers are created by applying a non-slip material on selective continuous portions, selective non-continuous portions, whole portions, or an entirety of the inner surface and the outer surface of the fabric structure. The continuous non-slip layers provide simultaneous gripping contact between the inner surface of the fabric structure and the user contact surface, and between the outer surface of the fabric structure and the external contact surface.

### CROSS-REFERENCE TO RELATED APPLICATIONS

This application claims priority to and the benefit of provisional patent application No. 61/971,613 titled “Gripping Garment With Continuous Non-slip Surfaces”, filed in the United States Patent and Trademark Office on Mar. 28, 2014. The specification of the above referenced patent application is incorporated herein by reference in its entirety.

### BACKGROUND

Conventional fabric materials are generally created by interlacing two distinct sets of yarns to form a fabric. A fabric created through a conventional manufacturing process has a low coefficient of friction and is not suitable for providing a gripping contact between the fabric and a user's body part that is in contact with the fabric of a garment, for example, a sock, a glove, etc. Moreover, conventional fabrics, due to their low coefficients of friction, cause slippage between the fabric of the garment and the surface of the body part in contact with the garment during use when they come in contact with elements, for example, sweat from the user's body, dust, moisture, air, etc. For example, in sports that involve running, skating, etc., where the user is required to quickly or abruptly change directions while engaged in a sports activity, the user's foot tends to slip inside a sock worn by the user, and also the sock tends to slip inside a shoe worn by the user due to a lack of sufficient grip between the foot and the sock and between the sock and the shoe respectively, when the sock is made of a conventional fabric. This slippage also increases a response time when the user moves in a direction different from the direction in which the user was originally moving. Lack of sufficient grip may also cause the foot of the user playing the sport to slip or cause the foot to roll inside the shoe and suffer injuries. For example, the foot of the user wearing a sock made of a conventional fabric and a shoe may slip inside the shoe during a sharp turn leading to an ankle injury. Moreover, the foot of the user wearing the shoe may slip within the sock made of the conventional fabric, which results in the foot moving inside the shoe, which may cause an injury to the foot or the ankle of the user. Socks constructed using conventional fabrics therefore do not provide sufficient grip to the user's foot when the user is engaged in a sports activity that requires sharp or abrupt turns.

Furthermore, different sports activities require a gripping contact to be established between different sections of the user's foot and a shoe worn by the user. For example, a user engaged in running would require a steady gripping contact between a forefoot section and a hind foot section of the user's foot and the shoe. Hence, there is a need for making a continuous non-slip layered sock that has continuous non-slip sections across the entire length of the sock from the heel to the toes.

Hence, there is a long felt but unresolved need for making a continuous non-slip layered garment, for example, a sock with continuous non-slip layers that provide a simultaneous selective grip or a complete grip to a user's body part, for example, the user's foot, between the user's body part and the continuous non-slip layered garment and also between the continuous non-slip layered garment and an external contact surface, for example, an inside surface of a shoe worn by the user to prevent the user's body part from slipping inside the continuous non-slip layered garment and to prevent the continuous non-slip layered garment from slipping against the external contact surface with which the continuous non-slip layered garment is in contact.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method disclosed herein addresses the above stated needs for making a continuous non-slip layered garment, for example, a sock with continuous non-slip layers that provide a simultaneous selective grip or a complete grip to a user's body part, for example, the user's foot, between the user's body part and the continuous non-slip layered garment and also between the continuous non-slip layered garment and an external contact surface, for example, the inside surface of a shoe worn by the user to prevent the user's body part from slipping inside the continuous non-slip layered garment and to prevent the continuous non-slip layered garment from slipping against the external contact surface with which the continuous non-slip layered garment is in contact. The method of making the continuous non-slip layered garment disclosed herein comprises creating a fabric structure comprising an inner surface and an outer surface, and creating a first continuous non-slip layer on the entire inner surface or substantially the entire inner surface of the created fabric structure and a second continuous non-slip layer on an entire outer surface or substantially the entire outer surface of the created fabric structure by applying a non-slip material, for example, a tacky material and/or a textured material on the entire inner surface or substantially the entire inner surface of the created fabric structure and on the entire outer surface or substantially the entire outer surface of the created fabric structure.

The fabric structure is configured to conform to a user's body part, for example, the user's foot. The inner surface of the fabric structure is proximal to a user contact surface, for example, the skin on the user's foot, and distal to an external contact surface, for example, the inside surface of a shoe worn by the user. The outer surface of the fabric structure is proximal to the external contact surface and distal to the user contact surface. The first continuous non-slip layer created on the entire inner surface or substantially the entire inner surface of the created fabric structure, and the second continuous non-slip layer created on the entire outer surface or substantially the entire outer surface of the created fabric structure are configured to provide simultaneous gripping contact between the entire inner surface or substantially the entire inner surface of the created fabric structure and the user contact surface, and between the entire outer surface or substantially the entire outer surface of the created fabric structure and the external contact surface.

In an embodiment, the method for making a continuous non-slip layered garment comprises creating a fabric structure comprising an inner surface and an outer surface, and creating continuous non-slip layers on the inner surface and the outer surface of the created fabric structure by applying a non-slip material on selective continuous portions or whole portions of the inner surface and the outer surface of the created fabric structure. The continuous non-slip layers created on the inner surface and the outer surface of the created fabric structure provide simultaneous gripping contact between the inner surface of the created fabric structure and the user contact surface, and between the outer surface of the created fabric structure and the external contact surface.

The continuous non-slip layered garment, for example, a sock, a glove, etc., with continuous non-slip layers provides a selective grip or a complete grip to a user's body part, for example, a foot, a hand, etc., between the user's body part and the continuous non-slip layered garment and prevents the user's body part from slipping inside the continuous non-slip layered garment. The continuous non-slip layered garment disclosed herein also provides a selective grip or a complete grip to the user's body part, for example, a foot between the continuous non-slip layered garment and an external contact surface, for example, the inside surface of a shoe worn by the user, to prevent the continuous non-slip layered garment from slipping against the external contact surface. The continuous non-slip layered garment disclosed herein also provides a simultaneous selective grip or a complete grip to a user's body part between the user's body part and the continuous non-slip layered garment and also between the continuous non-slip layered garment and an external contact surface to prevent the user's body part from slipping inside the continuous non-slip layered garment and to prevent the continuous non-slip layered garment from slipping against the external contact surface. For example, the continuous non-slip layered garment such as a continuous non-slip layered sock worn by the user provides grip to a user's foot between the user's foot and the continuous non-slip layered sock, and simultaneously provides grip to the user's foot between the continuous non-slip layered sock and the inside surface of a shoe worn by the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a method for making a continuous non-slip layered garment.

FIG. 2 illustrates an embodiment of the method for making a continuous non-slip layered garment.

FIGS. 3A-3G exemplarily illustrate perspective views of embodiments of a continuous non-slip layered garment comprising a fabric structure configured in the form of a sock, showing continuous non-slip layers created on the fabric structure.

FIG. 4 exemplarily illustrates multiple threads being separated and wound around spools for creating a fabric structure.

FIGS. 5A-5B exemplarily illustrate knitting of a first pair comprising a first non-slip thread and a first supplementary thread with a second pair comprising a second non-slip thread and a second supplementary thread for creating a fabric structure.

FIG. 6A exemplarily illustrates a perspective view of a fabric structure configured in the form of a sock.

FIG. 6B exemplarily illustrates an enlarged view of the fabric structure.

FIGS. 7A-7D exemplarily illustrate multiple views of the fabric structure, showing a first pair comprising a first non-slip thread and a first supplementary thread knitted with a second pair comprising a second non-slip thread and a second supplementary thread.

FIG. 8 exemplarily illustrates heat pressing of a non-slip material on an entire or substantially entire inner surface of a fabric structure and on an entire or substantially entire outer surface of the fabric structure.

FIG. 9A exemplarily illustrates heat pressing of a non-slip material configured into square shapes in contact with each other on a lower part of a fabric structure.

FIG. 9B exemplarily illustrates a perspective view of the continuous non-slip layered garment, showing the non-slip material configured in square shapes heat pressed on the lower part of the fabric structure.

FIG. 9C exemplarily illustrates heat pressing of a non-slip material configured into square shapes spaced apart from each other on selective continuous portions of the inner surface and the outer surface of a fabric structure in a pattern.

FIG. 9D exemplarily illustrates a right side elevation view of a continuous non-slip layered garment, showing the non-slip material heat pressed on selective continuous portions of the inner surface and the outer surface of the fabric structure in a pattern.

FIG. 9E exemplarily illustrates a rear perspective view of the continuous non-slip layered garment shown in FIG. 9D.

FIG. 10 exemplarily illustrates pouring of a non-slip material on an entire or substantially entire inner surface of a fabric structure and on an entire or substantially entire outer surface of the fabric structure.

FIG. 11 exemplarily illustrates spraying of a non-slip material on an entire or substantially entire inner surface of a fabric structure and on an entire or substantially entire outer surface of the fabric structure.

FIG. 12A exemplarily illustrates a perspective view of a continuous non-slip layered garment positioned on a sock form.

FIG. 12B exemplarily illustrates a sectional view of the continuous non-slip layered garment positioned on a sock form, taken along a sectional line XX in FIG. 12A.

FIG. 12C exemplarily illustrates a cutaway view of the continuous non-slip layered garment positioned on a sock form, showing three layers of the continuous non-slip layered garment.

FIG. 12D exemplarily illustrates an enlarged view of a cut portion marked P in FIG. 12C, showing the three layers of the continuous non-slip layered garment.

FIGS. 13A-13C exemplarily illustrate attaching a continuous non-slip layered patch to a lower part of a garment.

FIG. 13D exemplarily illustrates a perspective view showing a continuous non-slip layered garment made by attaching the continuous non-slip layered patch to the lower part of the garment.

FIG. 13E exemplarily illustrates a sectional view of the continuous non-slip layered garment taken along a sectional line YY in FIG. 13D.

FIGS. 14A-14C exemplarily illustrate attaching a continuous non-slip layered patch to an upper part of a garment.

FIG. 14D exemplarily illustrates a perspective view of a continuous non-slip layered garment made by attaching the continuous non-slip layered patch to the upper part of the garment.

FIG. 14E exemplarily illustrates a sectional view of the continuous non-slip layered garment taken along a sectional line ZZ in FIG. 14D.

FIG. 15A exemplarily illustrates spraying of a non-slip material on a fabric structure configured to conform to a user's body part to make a continuous non-slip layered garment.

FIG. 15B exemplarily illustrates an enlarged view of a sprayed portion of the fabric structure.

### DETAILED DESCRIPTION OF THE INVENTION

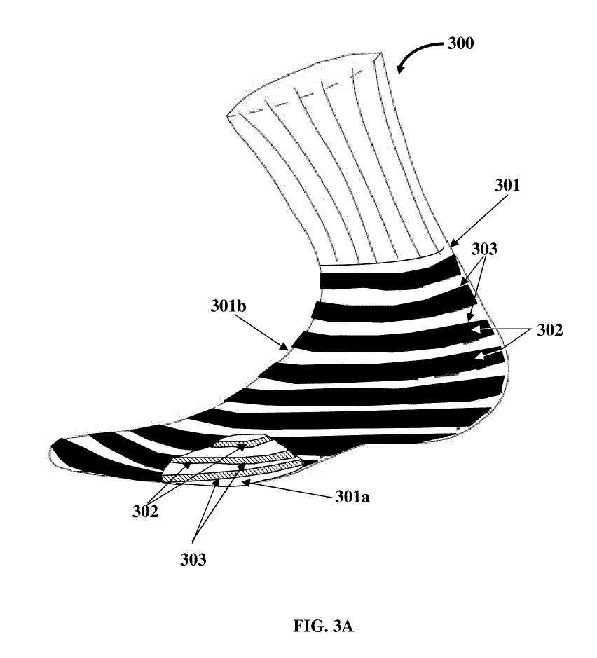

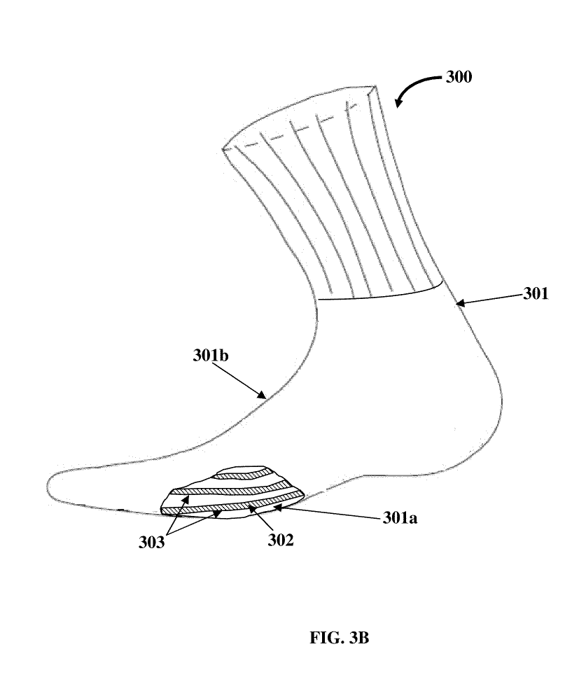

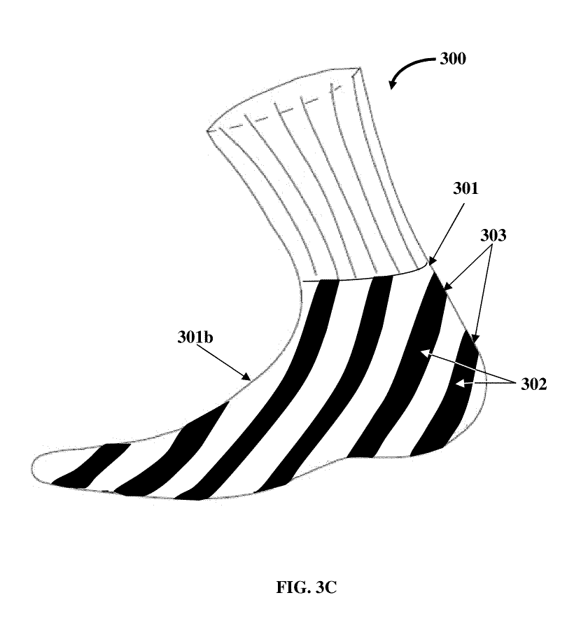

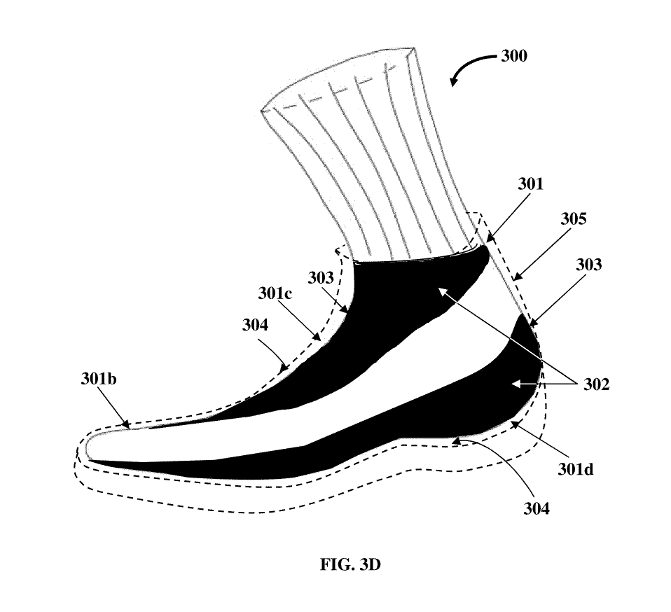

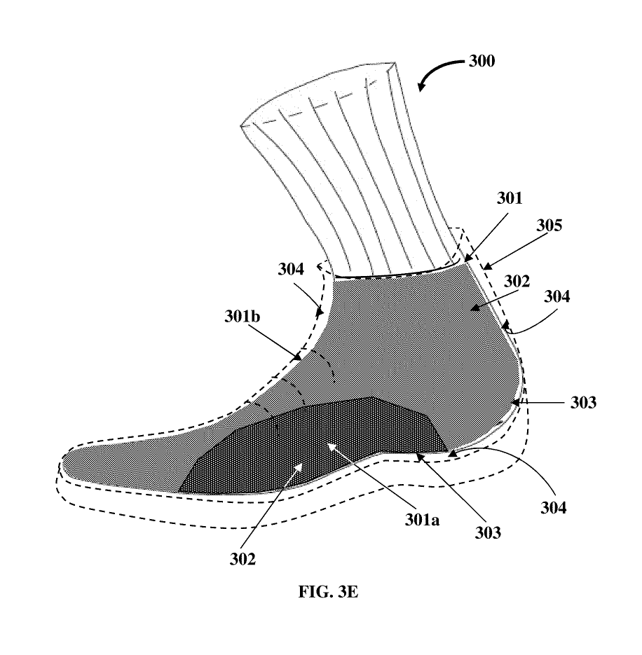

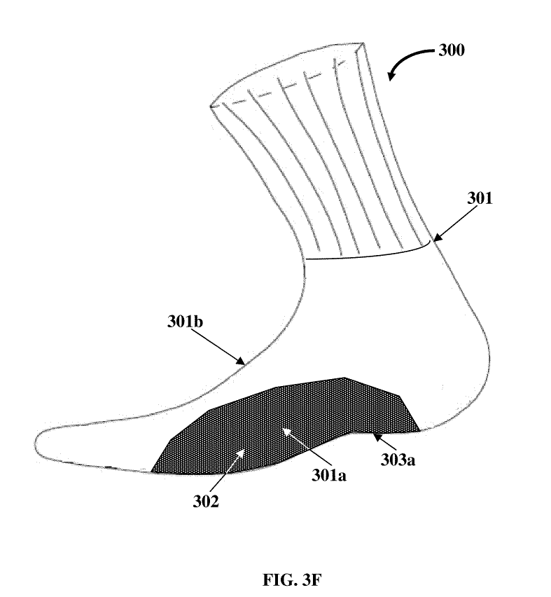

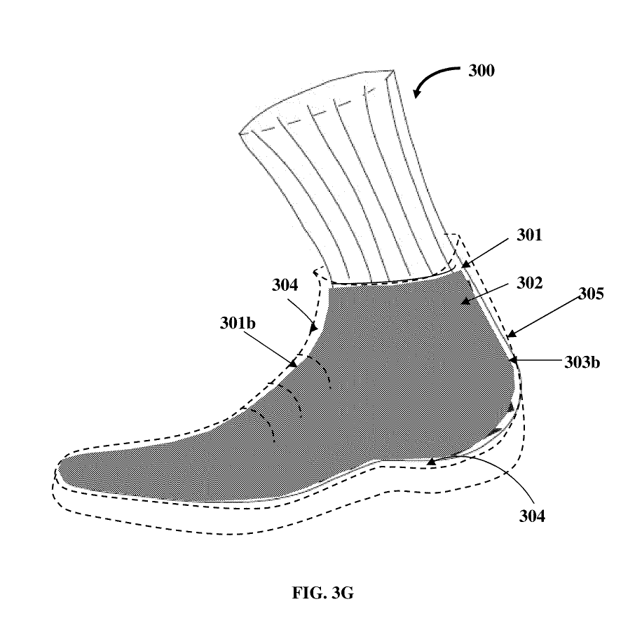

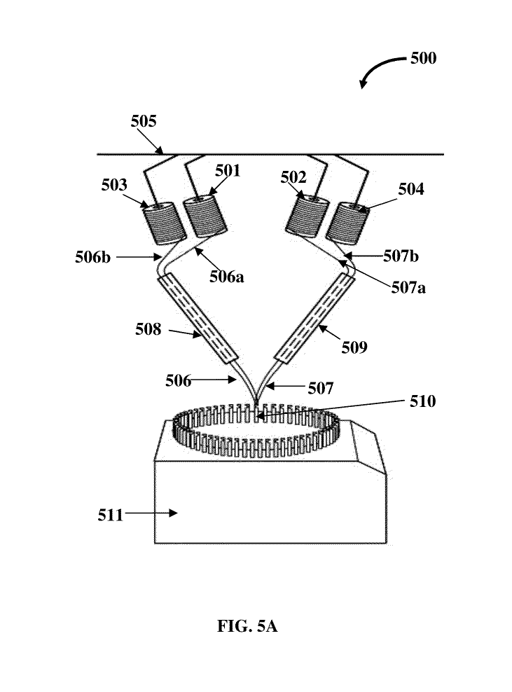

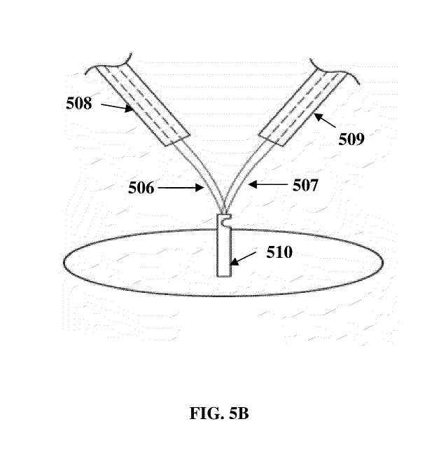

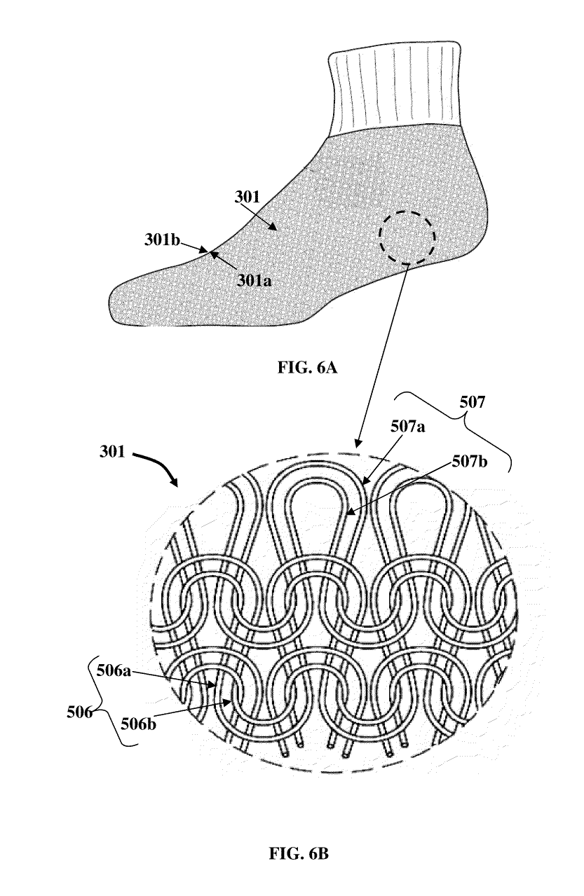

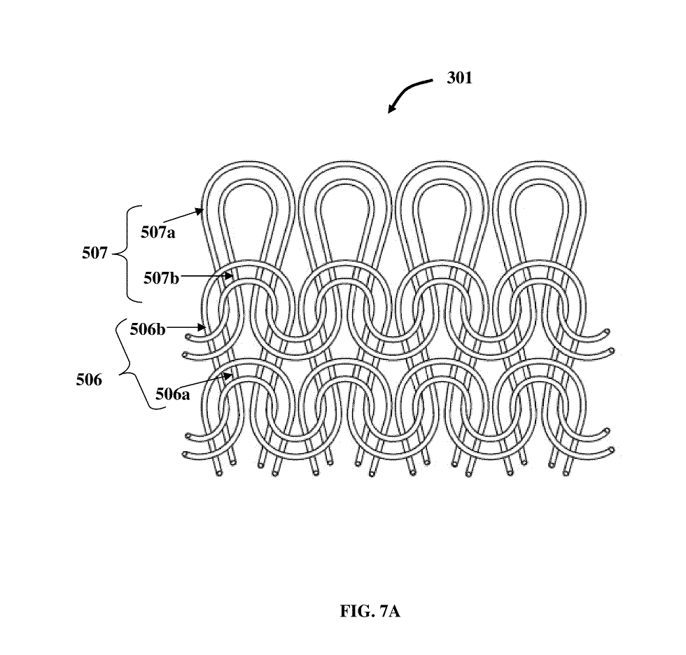

FIG. 1 illustrates a method for making a continuous non-slip layered garment 300 as exemplarily illustrated in FIG. 3E. The continuous non-slip layered garment 300, for example, a continuous non-slip layered sock, a continuous non-slip layered glove, etc., is made by configuring a fabric structure 301 exemplarily illustrated in FIGS. 6A-6B, to conform to a user's body part, for example, a foot, a hand, etc., and then applying a non-slip material 302 to the configured fabric structure 301 exemplarily illustrated in FIGS. 3A-3G. As used herein, “fabric structure” refers to a network of one of natural threads, synthetic threads, non-slip threads, or any combination thereof, that can be configured or knitted, for example, using a knitting machine 511 exemplarily illustrated in FIG. 5A, to construct a garment, for example, a sock, a glove, etc. Also, as used herein, “non-slip material” refers to a non-slip, sticky, gripping, tacky, and/or textured material that exhibits generally high surface adhesion and provides grip between the fabric structure 301 to which the non-slip material 302 is applied and a user contact surface, and simultaneously provides grip between the fabric structure 301 to which the non-slip material 302 is applied and an external contact surface. As used herein, “textured material” is any coarse or non-uniform finish material having, for example, a surface produced when Styrofoam® of the Dow Chemical Company is sprayed onto a surface or a substantial part of the surface. Also, as used herein, “user contact surface” refers to a surface, for example, the skin on a user's body part, for example, a foot, a hand, etc., that contacts an inner surface 301a of the fabric structure 301 exemplarily illustrated in FIGS. 3A-3B and FIGS. 3E-3F. Also, as used herein, “external contact surface” refers to a surface that is proximal to and in external contact with an outer surface 301b of the fabric structure 301 exemplarily illustrated in FIGS. 3A-3G. For example, the external contact surface 304 is the inside surface of a shoe 305 exemplarily illustrated in FIGS. 3D-3E and FIG. 3G, worn by the user, which externally contacts the outer surface 301b of a sock created from the fabric structure 301 and worn by the user on the user's foot. The inner surface 301a of the created fabric structure 301 is proximal to the user contact surface and distal to the external contact surface. The outer surface 301b of the created fabric structure 301 is proximal to the external contact surface and distal to the user contact surface. If the fabric structure 301 is configured to conform to a user's foot to construct a sock, when the user wears the sock and the shoe 305, the user contact surface is the skin of the user's foot and the external contact surface 304 is the inside surface of the user's shoe 305 exemplarily illustrated in FIGS. 3D-3E and FIG. 3G.

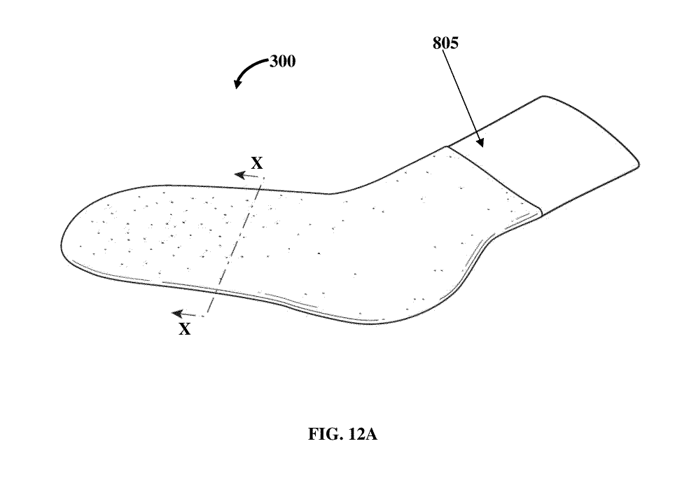

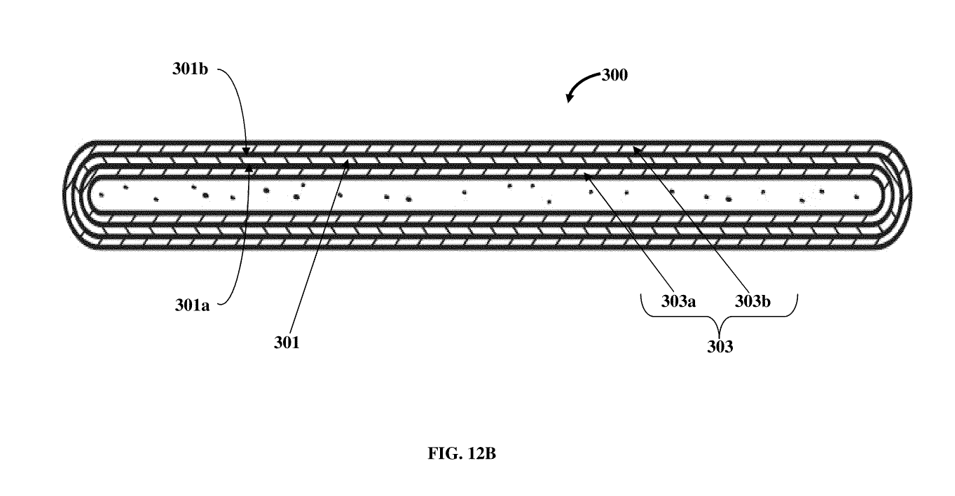

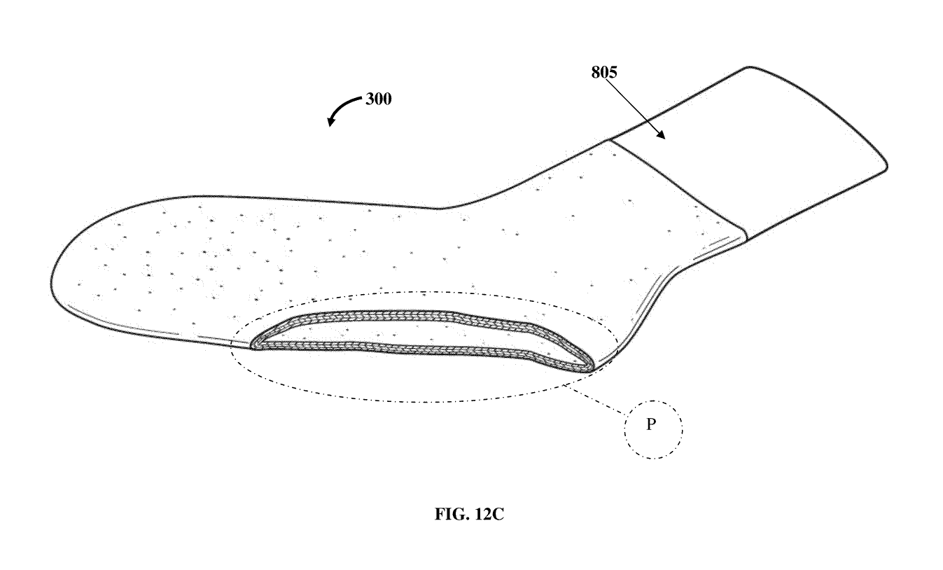

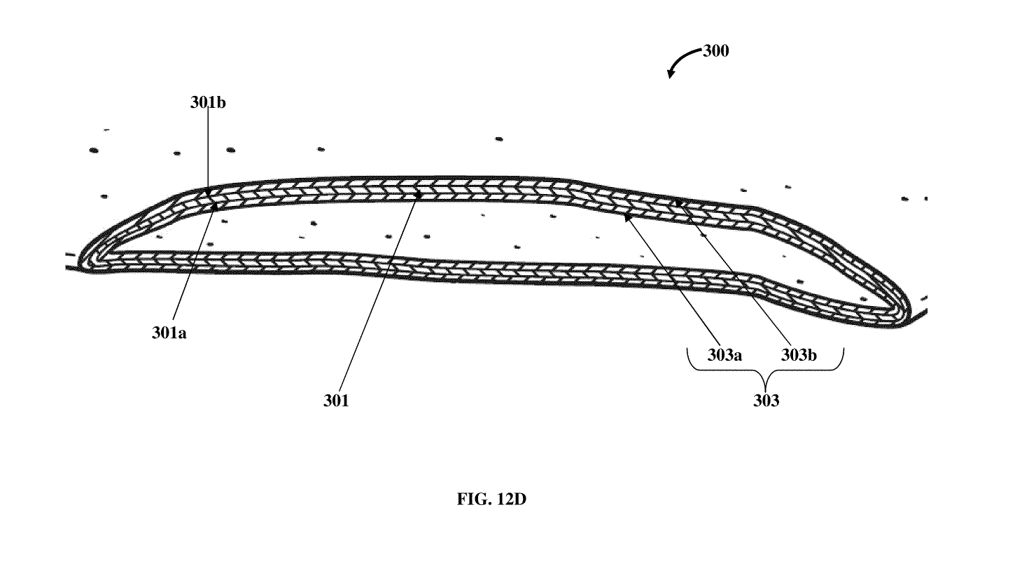

The method for making a continuous non-slip layered garment 300 disclosed herein comprises creating 101 a fabric structure 301 comprising an inner surface 301a and an outer surface 301b, and creating 102 a first continuous non-slip layer 303a on an entire or substantially entire inner surface 301a of the created fabric structure 301, and a second continuous non-slip layer 303b on an entire or substantially entire outer surface 301b of the created fabric structure 301 to make the continuous non-slip layered garment 300 exemplarily illustrated in FIG. 3E and FIGS. 12A-12B. As used herein, “continuous non-slip layer” refers to a continuous or substantially continuous surface or layer that is covered with the non-slip material 302. The continuous non-slip layers 303a and 303b are created by applying a non-slip material 302 on the entire or substantially the entire inner surface 301a of the created fabric structure 301 and on the entire or substantially the entire outer surface 301b of the created fabric structure 301. The application of the non-slip material 302 on the entire or substantially the entire inner surface 301a of the created fabric structure 301 and on the entire or substantially the entire outer surface 301b of the created fabric structure 301 is performed, for example, by one or more of heat pressing, spraying, pouring, painting, screen printing, and attaching the non-slip material 302 on the entire or substantially the entire inner surface 301a of the created fabric structure 301 and on the entire or substantially the entire outer surface 301b of the created fabric structure 301. The first continuous non-slip layer 303a created on the entire or substantially the entire inner surface 301a of the created fabric structure 301 and the second continuous non-slip layer 303b created on the entire or substantially the entire outer surface 301b of the created fabric structure 301 provides simultaneous gripping contact between the entire or substantially the entire inner surface 301a of the created fabric structure 301 and the user contact surface, and between the entire or substantially the entire outer surface 301b of the created fabric structure 301 and the external contact surface.

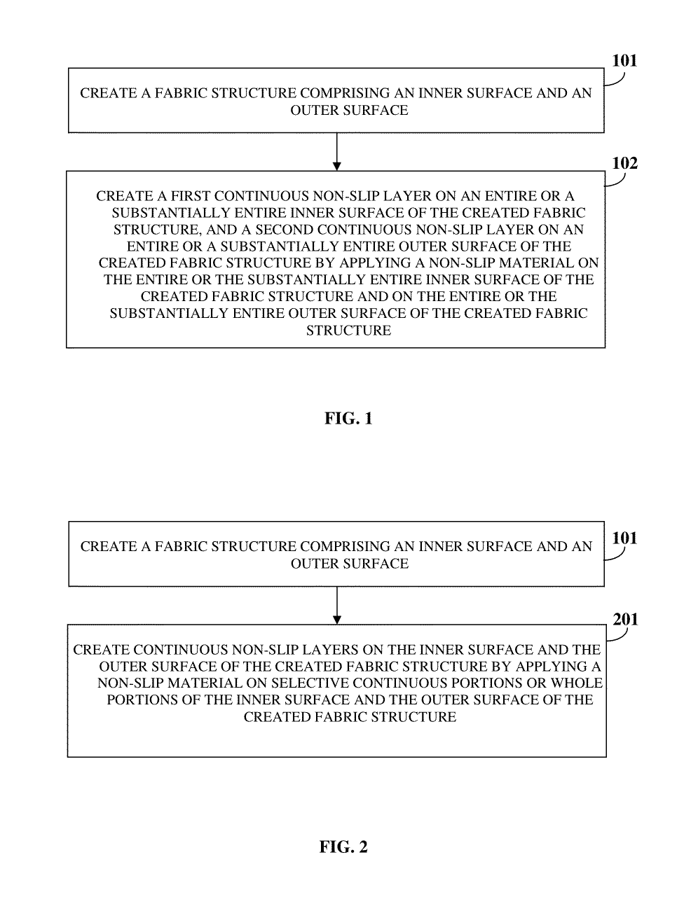

FIG. 2 illustrates an embodiment of the method for making a continuous non-slip layered garment 300 exemplarily illustrated in FIGS. 3A-3G. The method for making the continuous non-slip layered garment 300 comprises creating 101 a fabric structure 301 comprising an inner surface 301a and an outer surface 301b, and creating 201 continuous non-slip layers 303 on the inner surface 301a and the outer surface 301b of the created fabric structure 301 exemplarily illustrated in FIGS. 3A-3G and FIG. 12B, to make the continuous non-slip layered garment 300. In this embodiment, the continuous non-slip layers 303 are created on the inner surface 301a and the outer surface 301b of the created fabric structure 301 by applying a non-slip material 302 exemplarily illustrated in FIGS. 3A-3G, on selective continuous portions or whole portions of the inner surface 301a and the outer surface 301b of the created fabric structure 301. As used herein, “selective continuous portions” refers to continuous portions of the inner surface 301a and the outer surface 301b of the fabric structure 301 selected to provide grip to certain sections of a user's body part. For example, a selective continuous portion of a fabric structure 301 configured to form a sock may be a continuous portion running from an ankle section to a toe section of the sock. Another example of a selective continuous portion is a lower part or bottom of the sock from the heel section to the toe section of the sock. In this example, a continuous lower part of the sock is made out of the non-slip material 302, for example, a golf glove material such as a leather material, a synthetic material, a hybrid material, etc., while an upper part 301c of the sock is made out of a regular knit sock material. Also, as used herein, “whole portions” refers to the entire or substantially the entire inner surface 301a and the entire or substantially the entire outer surface 301b of the fabric structure 301.

In an embodiment, the non-slip material 302 is applied on selective continuous portions of both the inner surface 301a and the outer surface 301b of the fabric structure 301 configured, for example, as a sock as exemplarily illustrated in FIG. 3A. In another embodiment, the non-slip material 302 is applied on selective continuous portions of the inner surface 301a of the fabric structure 301 as exemplarily illustrated in FIG. 3B. In another embodiment, the non-slip material 302 is applied on selective continuous portions of the outer surface 301b of the fabric structure 301 as exemplarily illustrated in FIG. 3C. In another embodiment, the non-slip material 302 is applied on selective continuous portions of the fabric structure 301, for example, an upper part 301c and a lower part 301d of a foot section of the fabric structure 301 configured, for example, as a sock as exemplarily illustrated in FIG. 3D. In another embodiment, the non-slip material 302 is applied on the entire inner surface 301a and the entire outer surface 301b of the fabric structure 301 as exemplarily illustrated in FIG. 3E. In another embodiment, the non-slip material 302 is applied on a whole portion, that is, the entire or substantially the entire inner surface 301a of the fabric structure 301 as exemplarily illustrated in FIG. 3F. In another embodiment, the non-slip material 302 is applied on a whole portion, that is, the entire or substantially the entire outer surface 301b of the fabric structure 301 as exemplarily illustrated in FIG. 3G. In an embodiment, the non-slip material 302 is applied on selective non-continuous portions of both the inner surface 301a and the outer surface 301b of the fabric structure 301.

The continuous non-slip layers 303 created on the inner surface 301a and the outer surface 301b of the created fabric structure 301 provide simultaneous gripping contact between the inner surface 301a of the created fabric structure 301 and the user contact surface, and between the outer surface 301b of the created fabric structure 301 and the external contact surface. The continuous non-slip layer 303a created on the inner surface 301a of the created fabric structure 301 is configured to frictionally engage the user contact surface when the continuous non-slip layered garment 300 is worn, and the continuous non-slip layer 303b created on the outer surface 301b of the created fabric structure 301 is configured to frictionally engage the external contact surface 304, for example, the inside surface of a shoe 305 exemplarily illustrated in FIGS. 3D-3E and FIG. 3G, worn by a user, when the continuous non-slip layered garment 300 is worn against the external contact surface 304. Both the non-slip material 302 and the created fabric structure 301 provide resistance to sliding motion between the user contact surface and the continuous non-slip layer 303a created on the inner surface 301a of the created fabric structure 301, and a resistance to sliding motion between the continuous non-slip layer 303b created on the outer surface 301b of the created fabric structure 301 and the external contact surface 304. The resistance to sliding motion of the non-slip material 302 is greater than the resistance to sliding motion of the created fabric structure 301.

In the continuous non-slip layered garment 300 disclosed herein, the fabric structure 301 comprises, for example, a network of natural threads and/or synthetic threads, or a network of non-slip threads, or a network of one or more of natural threads, synthetic threads, and non-slip threads. As used herein, “non-slip threads” refer to gripping, sticky, tacky, and/or textured threads that exhibit generally high surface adhesion and provide grip between the user contact surface and a fabric structure 301 made from the non-slip threads, and simultaneously provide grip between the fabric structure 301 and the external contact surface. In an embodiment, the non-slip threads are made by applying a non-slip material 302 to natural threads and/or synthetic threads, for example, by spraying, painting, pouring, etc., the non-slip material 302 on the natural threads and/or synthetic threads. In an embodiment, the fabric structure 301 is configured to conform to a user's body part, for example, a foot, a hand, etc., for constructing a garment, for example, a sock, a glove, etc., prior to the application of the non-slip material 302 on selective continuous portions or whole portions of the inner surface 301a and the outer surface 301b of the fabric structure 301. For example, the natural threads, and/or the synthetic threads, and/or the non-slip threads are knitted using a knitting machine 511 exemplarily illustrated in FIG. 5A, to create and configure the fabric structure 301 into a sock, prior to the application of the non-slip material 302 on selective continuous portions or whole portions of the inner surface 301a and the outer surface 301b of the fabric structure 301.

In an embodiment, the non-slip material 302 is made in the form of a sheet having a thickness of, for example, 0.35 millimeters (mm). In an embodiment, the non-slip material 302 has a suede type finish and is classified as a non-woven fabric. The non-slip material 302 is made, for example, from natural rubber, synthetic rubber, natural latex, thermoplastic rubber (TPR), thermoplastic elastomers (TPE), polyurethane, polyvinyl chloride, synthetic and/or natural suede-like non-slip finishes, etc. In another example, the non-slip material 302 is a synthetic leather-like material, for example, Clarino® manufactured by Kuraray Co., Ltd., Tokyo, Japan.

Consider an example where a fabric structure 301 comprising a network of natural threads and/or synthetic threads is knitted, for example, using a knitting machine 511, to construct a garment, for example, a sock, a glove, etc. The non-slip material 302 is then applied on selective continuous portions or whole portions of each of the inner surface 301a and the outer surface 301b of the garment to make a continuous non-slip layered garment 300, for example, a continuous non-slip layered sock exemplarily illustrated in FIGS. 3A-3G. In an embodiment, the non-slip material 302 is applied on selective continuous portions or whole portions of the inner surface 301a and the outer surface 301b of the fabric structure 301, which is then configured into a continuous non-slip layered garment 300, for example, a continuous non-slip layered sock that provides grip between the user contact surface and the fabric structure 301, and also provides grip between the fabric structure 301 and the external contact surface 304 exemplarily illustrated in FIGS. 3D-3E and FIG. 3G. The continuous non-slip layered garment 300 can therefore be made by applying the non-slip material 302 to a fabric structure 301 that has already been knitted into a garment, for example, a sock, or by configuring the fabric structure 301 with the applied non-slip material 302 into a continuous non-slip layered garment 300.

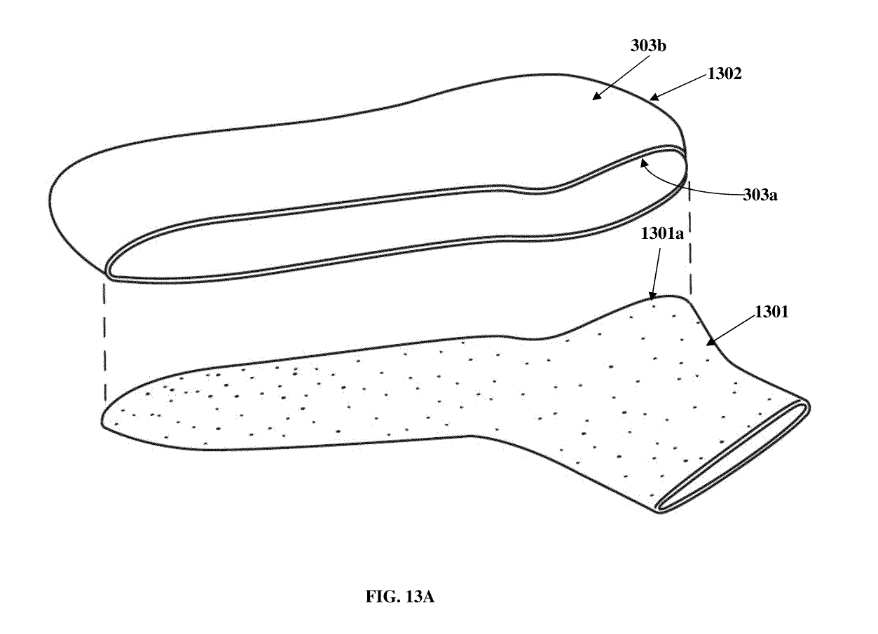

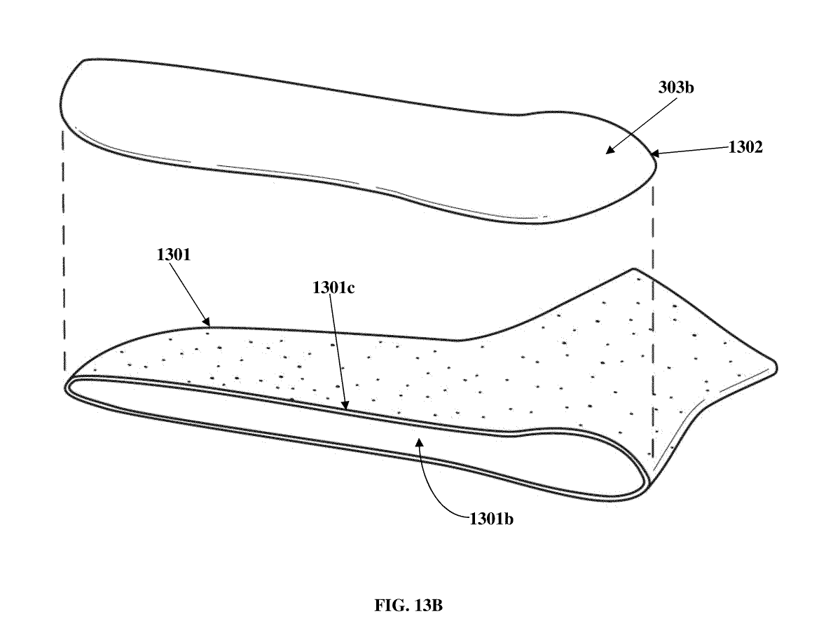

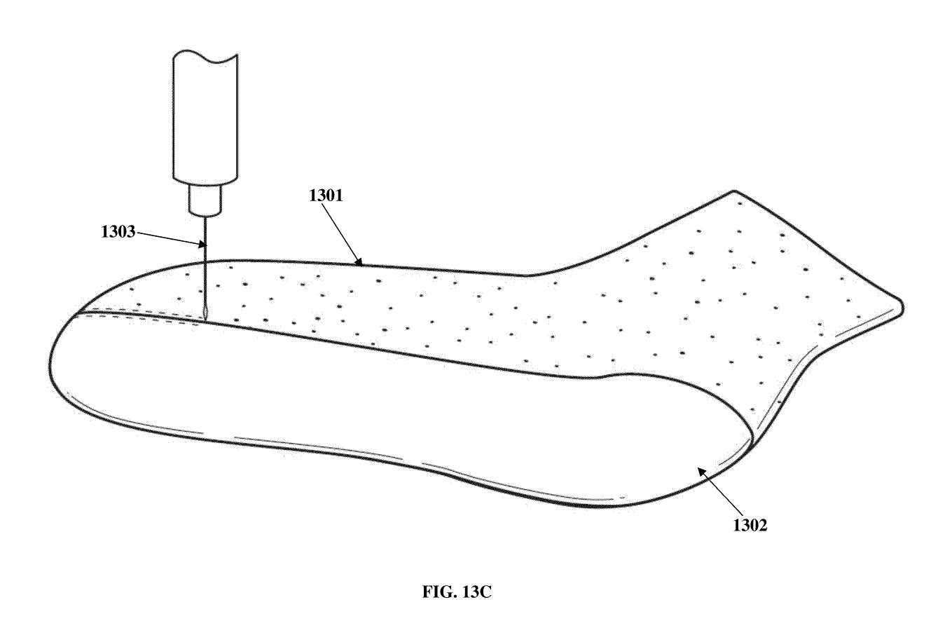

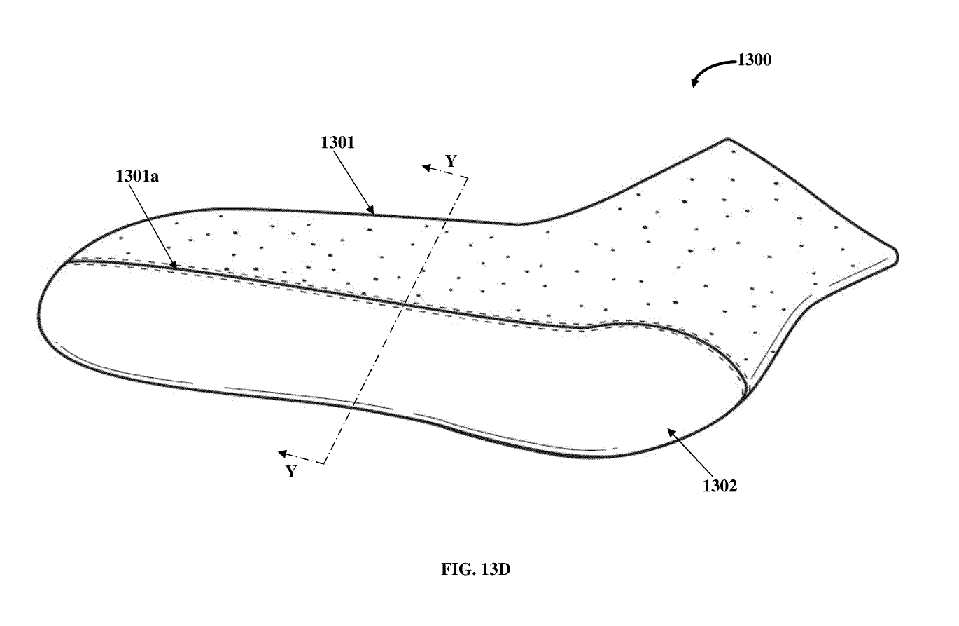

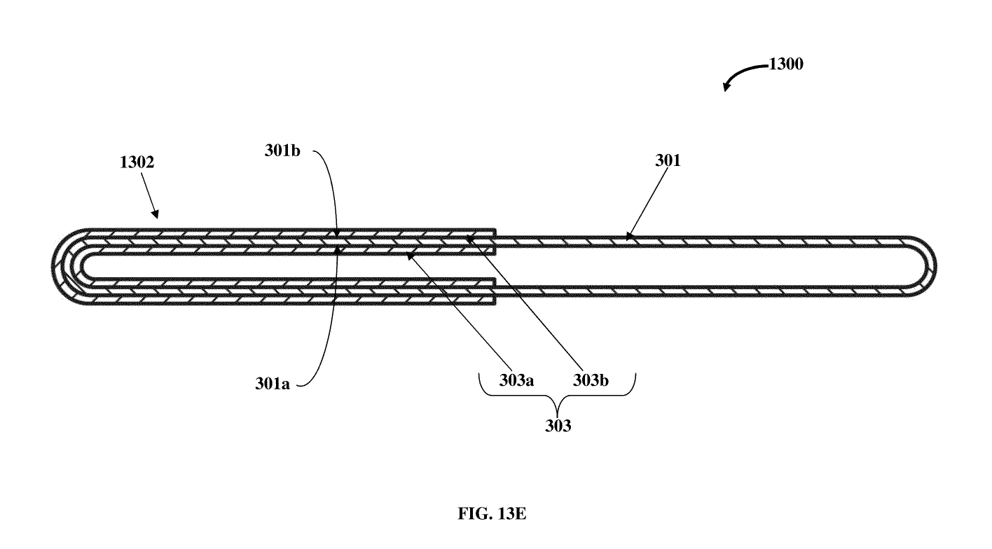

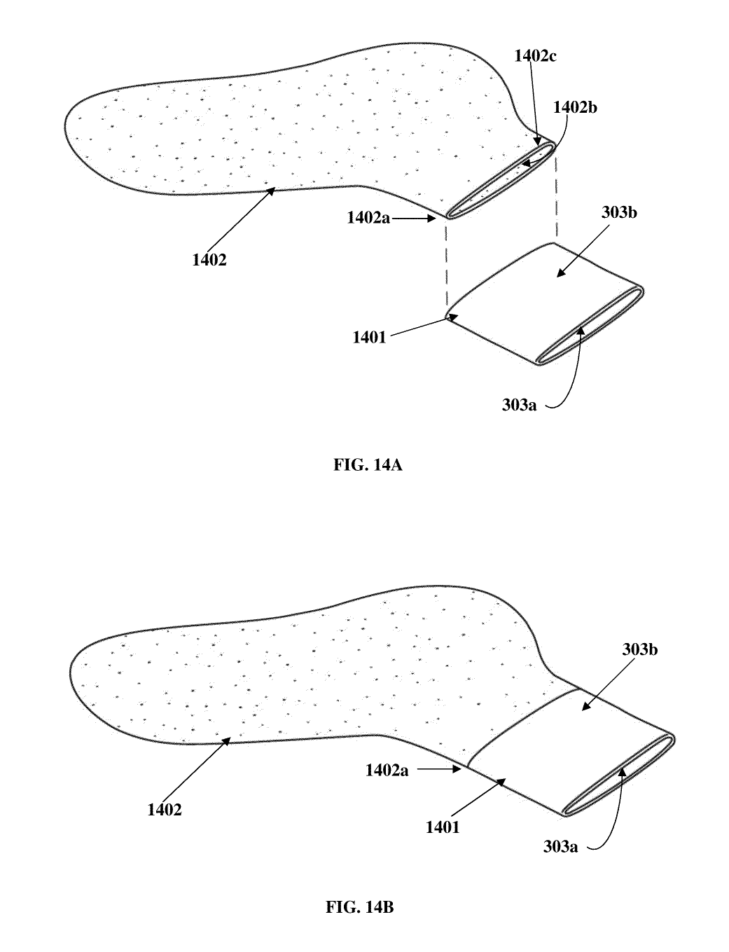

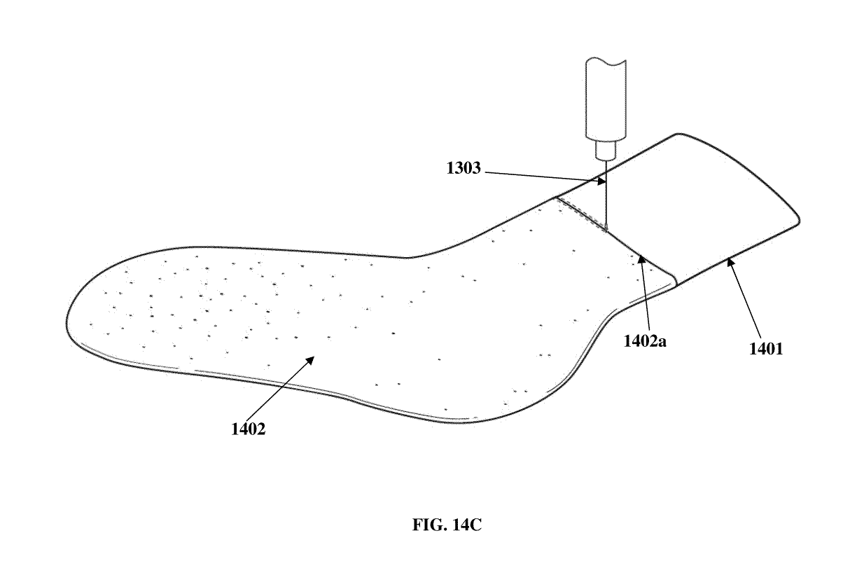

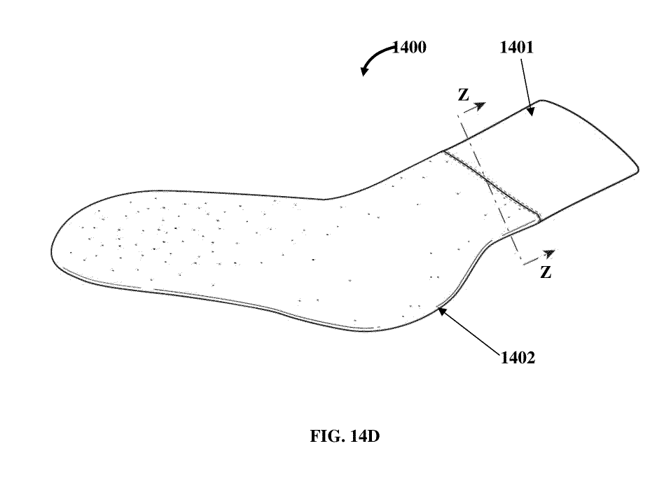

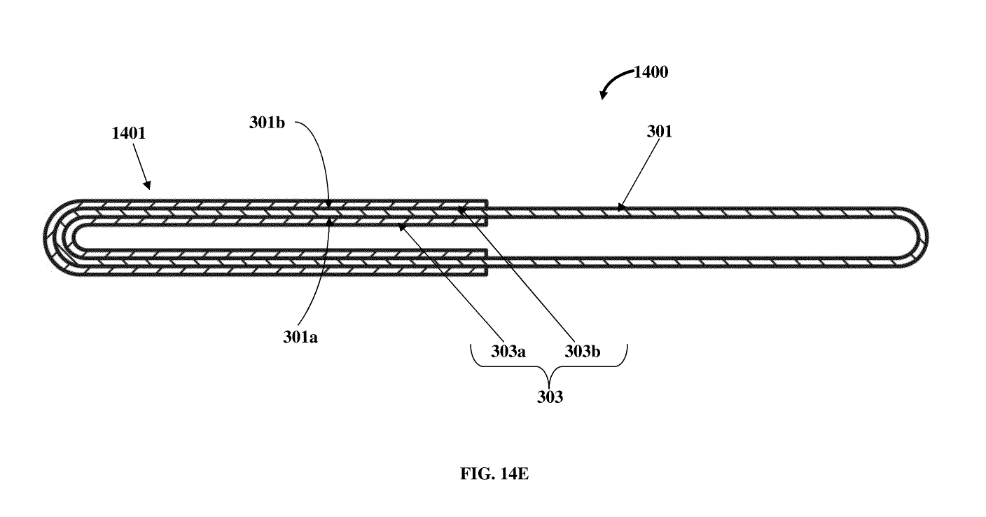

In an embodiment, the created fabric structure 301 with the applied non-slip material 302 is configured as a patch. The patch is attached or bonded to one or more sections of a garment wearable by a user for providing grip between the user contact surface and the patch, and for providing grip between the patch and the external contact surface. In an embodiment, the patch is attached, for example, to an inside surface and an outside surface of a garment wearable by the user, for example, by heat-gluing, pressure gluing, sewing, heat sealing, etc. In another embodiment, the patch 1302 or 1401 exemplarily illustrated in FIGS. 13A-13D and FIGS. 14A-14D, is sewn into an opening created in the garment wearable by the user. In another embodiment, the patch is, for example, made of a non-slip material 302, for example, a thermoplastic elastomer, a polyvinyl chloride, natural latex, synthetic latex, synthetic suede, suede leather, synthetic leather, other leathers, etc. The patch made of the non-slip material 302 is attached, for example, by sewing or bonding to one or more sections of a garment wearable by the user.

In an embodiment, the application of the non-slip material 302 on selective continuous portions or whole portions of the inner surface 301a and the outer surface 301b of the fabric structure 301 is performed, for example, by heat pressing the non-slip material 302 on the selective continuous portions or the whole portions of the inner surface 301a and the outer surface 301b of the fabric structure 301. Heat pressing is a method of applying heat and pressure on the fabric structure 301 for a predetermined period of time for transferring the non-slip material 302 to the inner surface 301a and the outer surface 301b of the fabric structure 301.

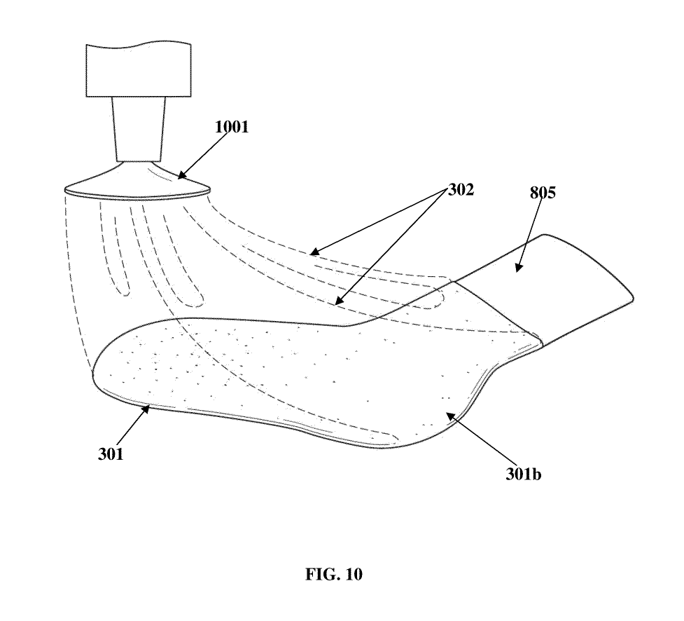

In another embodiment, the application of the non-slip material 302 on selective continuous portions or whole portions of the inner surface 301a and the outer surface 301b of the fabric structure 301 is performed, for example, by pouring the non-slip material 302 on the selective continuous portions or the whole portions of the inner surface 301a and the outer surface 301b of the fabric structure 301. In this embodiment, the fabric structure 301 is knitted, for example, using a circular knitting machine 511 exemplarily illustrated in FIG. 5A, into a sock and positioned over a framework, for example, a sock form 805 exemplarily illustrated in FIG. 10. A non-slip material 302 is then poured on selective continuous portions or whole portions of the inner surface 301a and the outer surface 301b of the fabric structure 301 of the sock. The non-slip material 302 then solidifies on the fabric structure 301 of the sock.

In another embodiment, the application of the non-slip material 302 on selective continuous portions or whole portions of the inner surface 301a and the outer surface 301b of the fabric structure 301 is performed, for example, by spraying the non-slip material 302 on the selective continuous portions or the whole portions of the inner surface 301a and the outer surface 301b of the fabric structure 301. In another embodiment, the application of the non-slip material 302 on selective continuous portions or whole portions of the inner surface 301a and the outer surface 301b of the fabric structure 301 is performed, for example, by painting or screen printing the non-slip material 302 on the selective continuous portions or the whole portions of the inner surface 301a and the outer surface 301b of the fabric structure 301. In another embodiment, the non-slip material 302 is attached to one or more selective continuous portions or sections of a garment or the entire or substantially the entire garment for providing grip between the user contact surface and the garment, and for providing grip between the garment and the external contact surface. In another embodiment, the non-slip material 302 may be applied to the inner surface of the external contact surface 304, for example, to the inside surface of a shoe 305 exemplarily illustrated in FIGS. 3D-3E and FIG. 3G, to enhance the grip between the fabric structure 301 and the external contact surface 304.

FIGS. 3A-3G exemplarily illustrate perspective views of embodiments of a continuous non-slip layered garment 300 comprising a fabric structure 301 configured in the form of a sock, showing continuous non-slip layers 303 created on the fabric structure 301. A non-slip material 302 applied on selective continuous portions or whole portions of the inner surface 301a and the outer surface 301b of the fabric structure 301 creates continuous non-slip layers 303 on the inner surface 301a and the outer surface 301b of the fabric structure 301 as disclosed in the detailed description of FIG. 2. In an embodiment, the non-slip material 302 is applied on selective continuous portions of both the inner surface 301a and the outer surface 301b of the fabric structure 301 of the sock as exemplarily illustrated in FIG. 3A. For example, the non-slip material 302 is configured into multiple continuous strips and attached horizontally on the inner surface 301a as exemplarily illustrated in a cutaway section of the fabric structure 301 in FIG. 3A, and on the outer surface 301b of the fabric structure 301 to create continuous non-slip layers 303 on both the inner surface 301a and the outer surface 301b of the fabric structure 301.

In another embodiment, the non-slip material 302 is applied on selective continuous portions of the inner surface 301a of the fabric structure 301 as exemplarily illustrated in FIG. 3B. For example, the non-slip material 302 is configured into continuous strips and attached horizontally on the inner surface 301a as exemplarily illustrated in a cutaway section of the fabric structure 301 in FIG. 3B, to create continuous non-slip layers 303 on the inner surface 301a of the fabric structure 301. In another embodiment, the non-slip material 302 is applied on selective continuous portions of the outer surface 301b of the fabric structure 301 as exemplarily illustrated in FIG. 3C. For example, the non-slip material 302 is configured into continuous strips and attached diagonally on the outer surface 301b of the fabric structure 301 to create continuous non-slip layers 303 on the outer surface 301b of the fabric structure 301 as exemplarily illustrated in FIG. 3C. In another embodiment, the non-slip material 302 is applied on an upper part 301c and a lower part 301d of a foot section of the fabric structure 301 as exemplarily illustrated in FIG. 3D, to create continuous non-slip layers 303 on selective parts 301c and 301d of the fabric structure 301. In this embodiment, both the inner surface 301a and the outer surface 301b of the upper part 301c and the lower part 301d of the foot section of the fabric structure 301 is made of the non-slip material 302. The continuous non-slip layers 303 created on the upper part 301c and the lower part 301d of the fabric structure 301 provides grip between a user contact surface, for example, the skin on the user's foot wearing the sock made of the fabric structure 301, and also provides grip between the sock and the external contact surface 304, for example, the inside surface of the shoe 305 worn by the user. In another embodiment, the non-slip material 302 is applied on either an upper part 301c or a lower part 301d of the foot section of the fabric structure 301. In this embodiment, both the inner surface 301a and the outer surface 301b of the upper part 301c or the lower part 301d of the foot section of the fabric structure 301 is made of the non-slip material 302.

In another embodiment as exemplarily illustrated in FIG. 3E, the non-slip material 302 is applied or coated on whole portions, that is, on the entire inner surface 301a of the fabric structure 301 as exemplarily illustrated in a cutaway section of the fabric structure 301 in FIG. 3E, and also on the entire outer surface 301b of the fabric structure 301, thereby creating continuous non-slip layers 303 on the entire fabric structure 301 and providing grip between a user contact surface, for example, the skin on the user's foot wearing the sock made of the fabric structure 301, and also providing grip between the sock and the external contact surface 304, for example, the inside surface of the user's shoe 305. In this embodiment, the entire fabric structure 301 both on the inside and outside is made of the gripping or non-slip material 302. In this embodiment, the fabric structure 301 is made, for example, of cotton and the entire inner surface 301a and the entire outer surface 301b of the fabric structure 301 is overlaid with the non-slip material 302. In another embodiment, the non-slip material 302 is applied on a whole portion, that is, the entire inner surface 301a of the fabric structure 301 as exemplarily illustrated in a cutaway section of the fabric structure 301 in FIG. 3F, to create a continuous non-slip layer 303a on the entire inner surface 301a of the fabric structure 301 that provides grip between a user contact surface, for example, the skin on the user's foot wearing the sock made of the fabric structure 301. In another embodiment, the non-slip material 302 is applied on a whole portion, that is, the entire outer surface 301b of the fabric structure 301 as exemplarily illustrated in FIG. 3G, to create a continuous non-slip layer 303b on the entire outer surface 301b of the fabric structure 301 that provides grip between the sock made of the fabric structure 301 and the external contact surface 304, for example, the inside surface of the user's shoe 305.

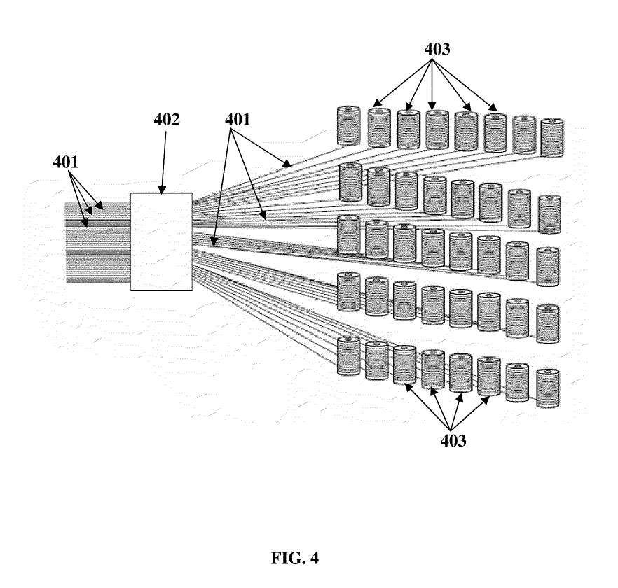

FIG. 4 exemplarily illustrates multiple threads 401 being separated and wound around spools 403 respectively for creating a fabric structure 301 exemplarily illustrated in FIGS. 6A-6B. The threads 401 are separated into and wound around separate spools 403 using a twisting machine 402. The threads 401 comprise non-slip threads and supplementary threads.

FIG. 5A exemplarily illustrates knitting of a first pair 506 comprising a first non-slip thread 506a and a first supplementary thread 506b with a second pair 507 comprising a second non-slip thread 507a and a second supplementary thread 507b for creating the fabric structure 301 exemplarily illustrated in FIGS. 6A-6B. As used herein, “supplementary thread” refers to an additional thread made from a conventional material, for example, cotton, nylon, polyester, wool, etc., which is knitted along with a non-slip thread to create the first pair 506 and the second pair 507. The first pair 506 defines the inner surface 301a of the fabric structure 301. The second pair 507 defines the outer surface 301b of the fabric structure 301. The non-slip threads 506a and 507a used for creating the fabric structure 301 are made from non-slip materials 302, tacky materials, and/or textured materials comprising, for example, one or more of synthetic rubber, natural latex, polyvinyl chloride, plastisol, thermoplastic rubber, thermoplastic elastomers, polyurethane, thermoplastic coatings on conventional threads, etc. The non-slip threads 506a and 507a are coated, for example, with silicon, talcum powder, etc., to prevent gathering and tangling during creation of the fabric structure 301. The supplementary threads 506b and 507b are selected from materials comprising, for example, cotton, nylon, polyester, or spandex such as Lycra® of E. I. du Pont de Nemours and Company, wool, acrylic, etc.

The non-slip threads 506a and 507a are separated out of a box into first non-slip threads 506a and second non-slip threads 507a. Consider an example where a first non-slip thread 506a, a second non-slip thread 507a, a first supplementary thread 506b, and a second supplementary thread 507b are wound onto a first spool 501, a second spool 502, a third spool 503, and a fourth spool 504 respectively. The first spool 501 of the first non-slip thread 506a and the third spool 503 of the first supplementary thread 506b are placed onto a rack 505 positioned on a knitting unit 500, above a first finger tube 508 as exemplarily illustrated in FIG. 5A. The second spool 502 of the second non-slip thread 507a and the fourth spool 504 of the second supplementary thread 507b are placed onto the rack 505 positioned on the knitting unit 500, above a second finger tube 509 as exemplarily illustrated in FIG. 5A.

To create the inner surface 301a of the fabric structure 301, the first non-slip thread 506a and the first supplementary thread 506b from the first spool 501 and the third spool 503 respectively are simultaneously fed into the first finger tube 508 as exemplarily illustrated in FIG. 5A. The first non-slip thread 506a and the first supplementary thread 506b are grouped into a first pair 506 that defines the inner surface 301a of the fabric structure 301 exemplarily illustrated in FIGS. 6A-6B. To create the outer surface 301b of the fabric structure 301, the second non-slip thread 507a and the second supplementary thread 507b from the second spool 502 and the fourth spool 504 respectively are fed simultaneously into the second finger tube 509 as exemplarily illustrated in FIG. 5A. The second non-slip thread 507a and the second supplementary thread 507b are grouped into a second pair 507 that defines the outer surface 301b of the fabric structure 301 exemplarily illustrated in FIGS. 6A-6B.

The first pair 506 and the second pair 507 are retrieved from the first finger tube 508 and the second finger tube 509 respectively and knitted, for example, using a latch needle 510 of a knitting machine 511 exemplarily illustrated in FIGS. 5A-5B, for creating the fabric structure 301 exemplarily illustrated in FIG. 6B. The knitting machine 511 is, for example, a Lonati 454 machine, Lonati Co., Brescia, Italy. The first pair 506 is knitted with the second pair 507 to form the fabric structure 301 using one or more of multiple latch needles 510 in the circular knitting machine 511 as exemplarily illustrated in FIG. 5A. The technique of knitting one or more pairs 506 of threads 506a and 506b to define the inner surface 301a of the fabric structure 301 and one or more pairs 507 of the same or different material threads 507a and 507b to define the outer surface 301b of the fabric structure 301 is known as plating. The first non-slip thread 506a of the first pair 506 is exposed on the inner surface 301a of the fabric structure 301. The first non-slip thread 506a of the first pair 506 is not exposed on the outer surface 301b of the fabric structure 301. The second non-slip thread 507a of the second pair 507 is exposed on the outer surface 301b of the fabric structure 301. The second non-slip thread 507a of the second pair 507 is not exposed on the inner surface 301a of the fabric structure 301.

In an embodiment, the fabric structure 301 comprising the inner surface 301a and the outer surface 301b is created by feeding the first non-slip thread 506a, the second non-slip thread 507a, the first supplementary thread 506b, and the second supplementary thread 507b into a first finger tube (not shown), a second finger tube (not shown), a third finger tube (not shown), and a fourth finger tube (not shown) respectively. A plating technique is used, for example, to knit the first supplementary thread 506b retrieved from the third finger tube and the second supplementary thread 507b retrieved from the fourth finger tube. The first supplementary thread 506b is exposed on the inner surface 301a of the fabric structure 301. The second supplementary thread 507b is exposed on the outer surface 301b of the fabric structure 301. The plating technique is also used to knit the first non-slip thread 506a retrieved from the first finger tube and the second non-slip thread 507a retrieved from the second finger tube. The first non-slip thread 506a is exposed on the inner surface 301a of the fabric structure 301. The first non-slip thread 506a is not exposed on the outer surface 301b of the fabric structure 301. The second non-slip thread 507a is exposed on the outer surface 301b of the fabric structure 301. The second non-slip thread 507a is not exposed on the inner surface 301a of the fabric structure 301.

FIG. 5B exemplarily illustrates knitting the first pair 506 and the second pair 507 using a latch needle 510 for creating the fabric structure 301 exemplarily illustrated in FIGS. 6A-6B. The latch needle 510 receives the first pair 506 of threads 506a and 506b and the second pair 507 of threads 507a and 507b at the same time to form the inner surface 301a and the outer surface 301b of the fabric structure 301 simultaneously. The gauge of the first non-slip thread 506a and the second non-slip thread 507a is, for example, in the range of about 0.3 millimeter diameter to about 1 millimeter diameter.

In an embodiment, the fabric structure 301 is created without the use of a conventional supplementary thread, for example, by knitting only non-slip threads 506a and 507a to define the entire inner surface 301a and the entire outer surface 301b of the fabric structure 301. In this embodiment, the non-slip threads 506a and 507a are used exclusively to create the inner surface 301a and the outer surface 301b of the fabric structure 301. In another embodiment, the fabric structure 301 configured to conform to the user's body part, for example, the user's foot, comprises one or more non-slip threads 506a and 507a in selective continuous portions, for example, a heel section that accommodates the user's heel, a ball section that accommodates the ball of the user's foot, etc., on the inner surface 301a and the outer surface 301b of the created fabric structure 301.

In an embodiment, the non-slip material 302 is applied on the first non-slip thread 506a and/or the first supplementary thread 506b in the first pair 506 that defines the inner surface 301a of the fabric structure 301, and on the second non-slip thread 507a and/or the second supplementary thread 507b in the second pair 507 that defines the outer surface 301b of the fabric structure 301. For example, the non-slip material 302 can be added to or coated on the first non-slip thread 506a and/or the first supplementary thread 506b in the first pair 506, or on the second non-slip thread 507a and/or the second supplementary thread 507b in the second pair 507 at 1/16^{th} of an inch intervals instead of coating the entire length of the threads 506a, 506b, 507a, and 507b on the spools 501, 503, 502, and 504 respectively exemplarily illustrated in FIG. 5A.

In an embodiment, the non-slip material 302 can be added to or coated on the entire length of the first non-slip thread 506a and/or the first supplementary thread 506b in the first pair 506, or on the second non-slip thread 507a and/or the second supplementary thread 507b in the second pair 507. The non-slip material 302 adheres to the first non-slip thread 506a and/or the first supplementary thread 506b in the first pair 506 and to the second non-slip thread 507a and/or the second supplementary thread 507b in the second pair 507. The non-slip material 302 on the inner surface 301a defined by the first pair 506 and the outer surface 301b defined by the second pair 507 adheres to the user contact surface and the external contact surface respectively, for providing enhanced grip between the user contact surface and the fabric structure 301, and between the fabric structure 301 and the external contact surface respectively.

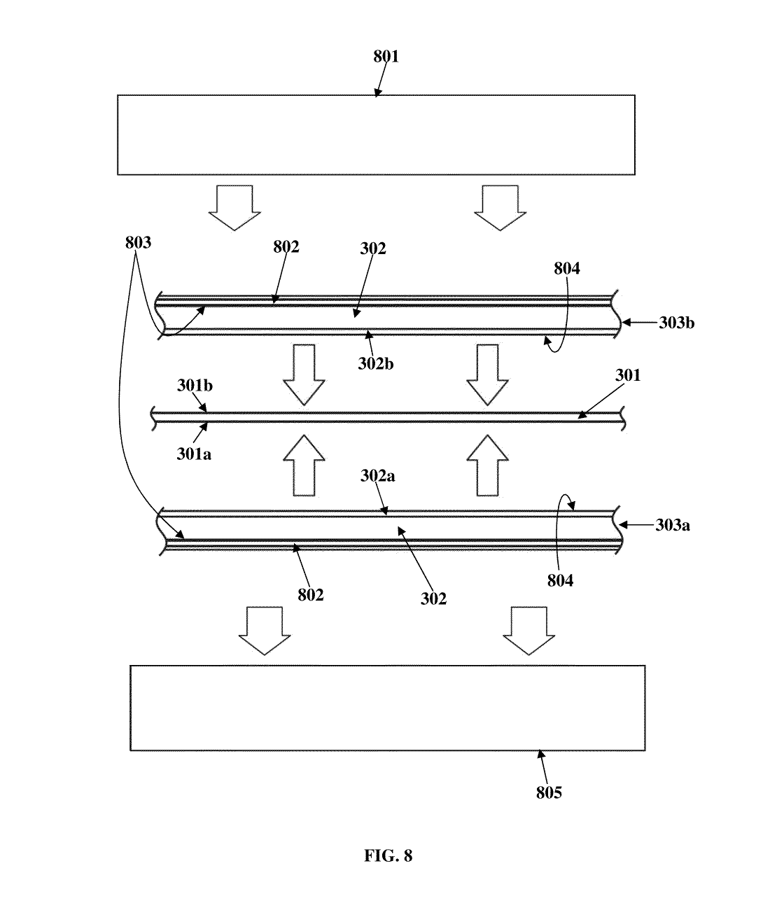

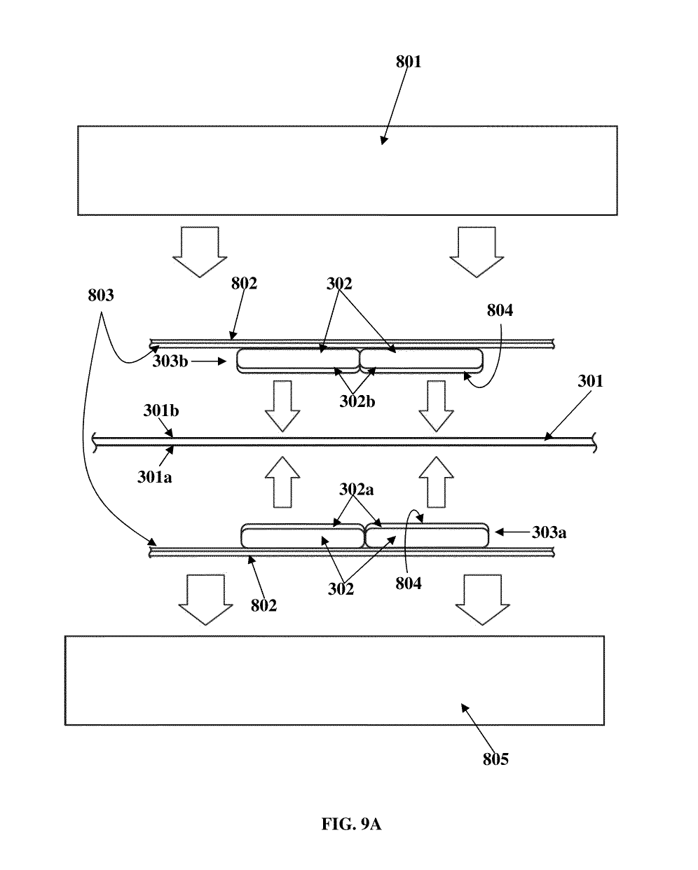

FIG. 6A exemplarily illustrates a perspective view of a fabric structure 301 configured in the form of a sock to conform to a user's foot. The fabric structure 301 comprises an inner surface 301a and an outer surface 301b. A non-slip material 302 is applied on the inner surface 301a and the outer surface 301b of the configured fabric structure 301 as exemplarily illustrated in FIGS. 8-11 and as disclosed in the detailed description of FIGS. 8-11.

FIG. 6B exemplarily illustrates an enlarged view of the fabric structure 301. The fabric structure 301 comprises an inner surface 301a and an outer surface 301b as exemplarily illustrated in FIG. 6A. The inner surface 301a of the fabric structure 301 is defined by a first pair 506 comprising a first non-slip thread 506a and a first supplementary thread 506b, and the outer surface 301b of the fabric structure 301 is defined by a second pair 507 comprising a second non-slip thread 507a and a second supplementary thread 507b as exemplarily illustrated in FIG. 6B.

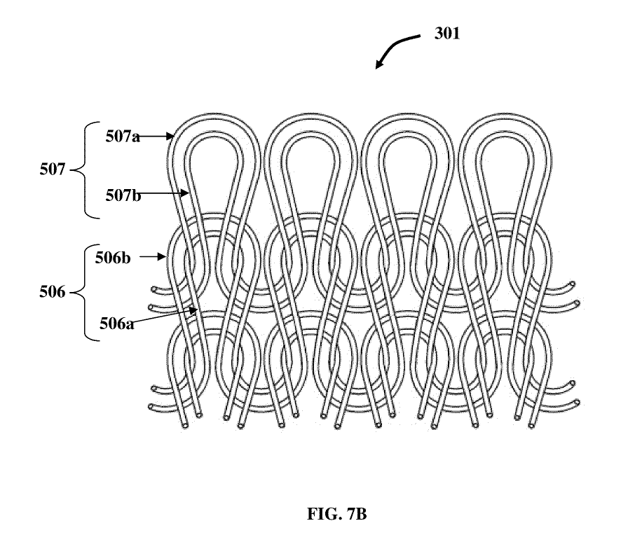

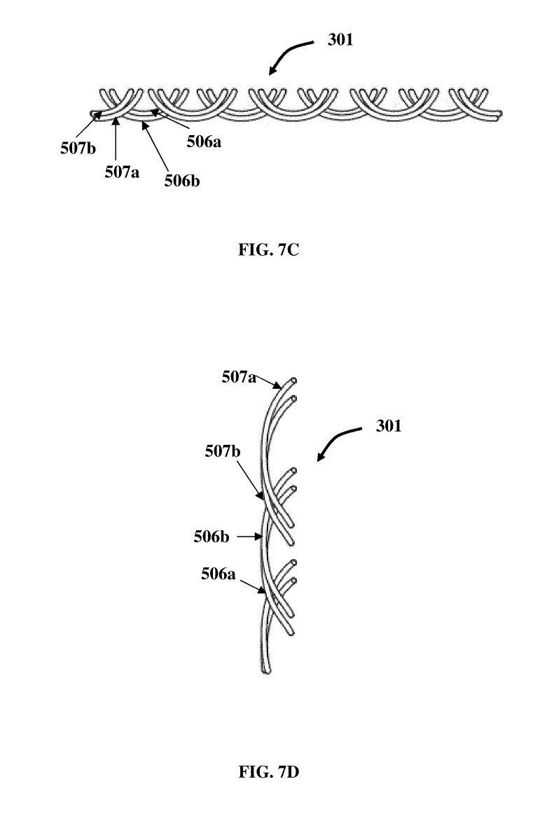

FIGS. 7A-7D exemplarily illustrate multiple views of the fabric structure 301 shown in FIGS. 6A-6B, showing a first pair 506 comprising a first non-slip thread 506a and a first supplementary thread 506b knitted with a second pair 507 comprising a second non-slip thread 507a and a second supplementary thread 507b. A bottom elevation view, a top view, and side views of the first pair 506 comprising the first non-slip thread 506a and the first supplementary thread 506b knitted with the second pair 507 comprising the second non-slip thread 507a and the second supplementary thread 507b are exemplarily illustrated in FIG. 7A, FIG. 7B, and FIGS. 7C-7D respectively. The fabric structure 301 is made of traction, gripping yarn herein referred to as a first non-slip thread 506a and a second non-slip thread 507a, knitted with yarns made of a conventional material herein referred to as supplementary threads 506b and 507b. The first non-slip thread 506a and the second non-slip thread 507a are made of the same material. In an embodiment, the first non-slip thread 506a and the second non-slip thread 507a are made of different traction, non-slip materials. The first non-slip thread 506a and the second non-slip thread 507a are, for example, made of a synthetic material such as a synthetic rubber, or a natural material such as latex also known as a natural rubber, or yarns coated with natural latex, polyvinyl chloride, thermoplastic rubber or thermoplastic elastomers, polyurethane, etc. In an embodiment, the non-slip threads 506a and 507a are extruded vulcanized natural latex, gauge 68 and 75, made by the following company: Heveafil Sdn. Bdh., No. 1, Jalan Heveafil, 44300 Batang Kali, Ulu Selangor, Selangor Darul Ehsan, Malaysia.

The supplementary threads 506b and 507b are made, for example, of materials such as cotton, nylon, Lycra®, acrylic, wool or other conventional materials used in the manufacture of, for example, socks, gloves, etc. In an embodiment, the fabric structure 301 comprises a first type of supplementary thread 506b used to define the inner surface 301a of the fabric structure 301 and a second type of supplementary thread 507b used to define the outer surface 301b of the fabric structure 301. For example, the first supplementary thread 506b used to define the inner surface 301a of the fabric structure 301, that accompanies the first non-slip thread 506a, is made of cotton, while the second supplementary thread 507b used to define the outer surface 301b of the fabric structure 301, that accompanies the second non-slip thread 507a is made of nylon. In an embodiment, the supplementary threads 506b and 507b used for the inner surface 301a and the outer surface 301b are made of the same material.

For purposes of illustration, the detailed description of FIGS. 5A-7D refers to the creation of the fabric structure 301 by knitting a first pair 506 comprising a first non-slip thread 506a and a first supplementary thread 506b, and a second pair 507 comprising a second non-slip thread 507a and a second supplementary thread 507b. However, the scope of the method disclosed herein is not limited to the first pair 506 and the second pair 507 but may be extended to include multiple pairs of multiple threads. In an embodiment, the first pair 506 of threads 506a and 506b and the second pair 507 of threads 507a and 507b are knitted to create the fabric structure 301 such that the inner surface 301a of the fabric structure 301 and the outer surface 301b of the fabric structure 301 are made of threads of the same non-slip material-supplementary material. In an embodiment, different non-slip material-supplementary material thread combinations are used for creation of the fabric structure 301.

FIG. 8 exemplarily illustrates heat pressing of a non-slip material 302 on an entire or substantially entire inner surface 301a of a fabric structure 301 and on an entire or substantially entire outer surface 301b of the fabric structure 301 using a heat press 801. A fabric structure 301 comprising, for example, natural threads and/or synthetic threads, that defines an inner surface 301a and an outer surface 301b is created as disclosed in the detailed description of FIGS. 5A-7D. In this embodiment, the application of sheets of non-slip material 302 on the entire or substantially the entire inner surface 301a of the fabric structure 301 and on the entire or substantially the entire outer surface 301b of the fabric structure 301 is performed, for example, by heat pressing for transferring the sheets of non-slip material 302 to the inner surface 301a and the outer surface 301b of the fabric structure 301.

The sheets of non-slip material 302 are cut, for example, by laser cutting, die cutting, rotary cutting, etc., to a required specification and aligned on a transfer material 802, for example, made of paper. The sheet of non-slip material 302 is attached to the transfer material 802 using a temporary adhesive 803 provided on the transfer material 802. The temporary adhesive 803 holds the non-slip material 302 in place until the non-slip material 302 is heat pressed onto the fabric structure 301 by using the heat press 801. In an embodiment, surfaces 302b and 302a of the sheets of non-slip material 302 are coated with a sealing element, for example, a heat seal adhesive 804 such as Bemis 3218 manufactured by Bemis Associates Inc., Massachusetts, USA, a fabric glue, a polyurethane heat seal, etc. Bemis 3218 is a fully reacted elastomeric film that remains flexible over a wide temperature range. Bemis 3218 is a general purpose adhesive that combines a low activation temperature with a very high viscosity at its softening point.

The transfer material 802 that carries each sheet of non-slip material 302 is positioned above and below the fabric structure 301 as exemplarily illustrated in FIG. 8, with the non-slip material 302 facing the outer surface 301b and the inner surface 301a of the fabric structure 301 respectively. The transfer material 802 with the sheet of non-slip material 302 positioned below the fabric structure 301 rests on the sock form 805. Heat at a predetermined temperature, for example, about 375 degrees Fahrenheit (F) and pressure is applied on the transfer material 802 that carries the sheet of non-slip material 302 above the fabric structure 301 for about 20 seconds using the heat press 801. The heat press 801 compresses the sheets of non-slip material 302 towards the outer surface 301b and the inner surface 301a of the fabric structure 301, resulting in the transfer of the sheets of non-slip material 302 to the outer surface 301b and the inner surface 301a of the fabric structure 301. Due to the application of heat, the sheets of non-slip material 302 peels off from the transfer material 802 and permanently bond to the outer surface 301b and the inner surface 301a of the fabric structure 301, thereby creating continuous non-slip layers 303b and 303a on the outer surface 301b and the inner surface 301a of the fabric structure 301 respectively. The transfer material 802 is thereafter removed from the fabric structure 301.

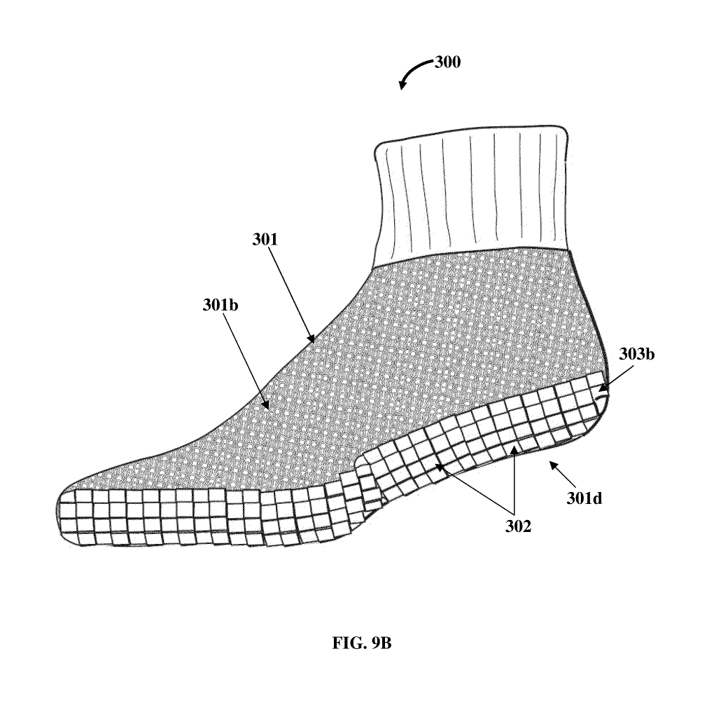

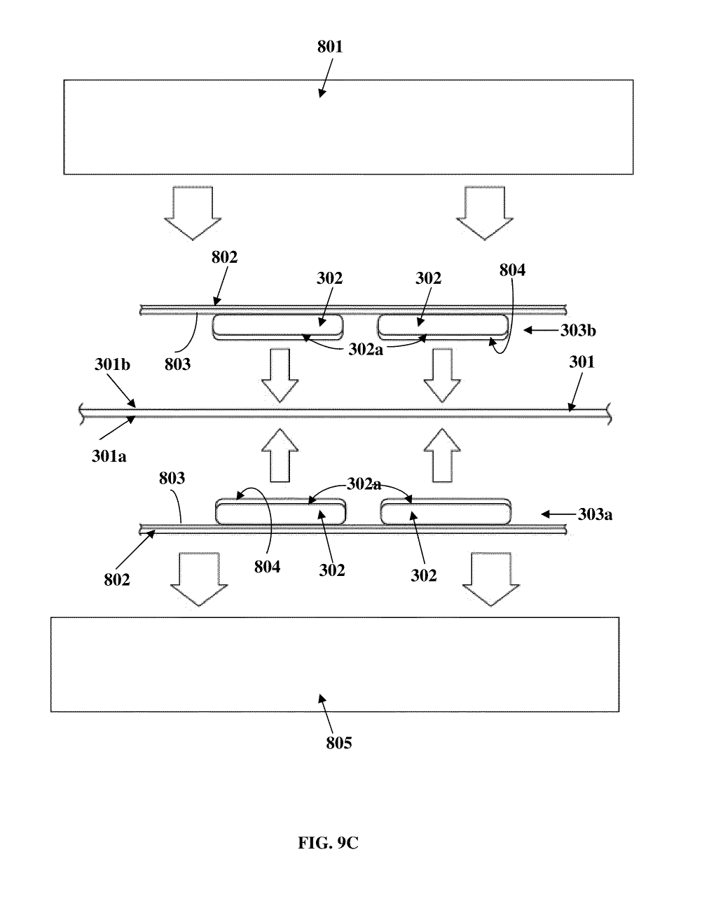

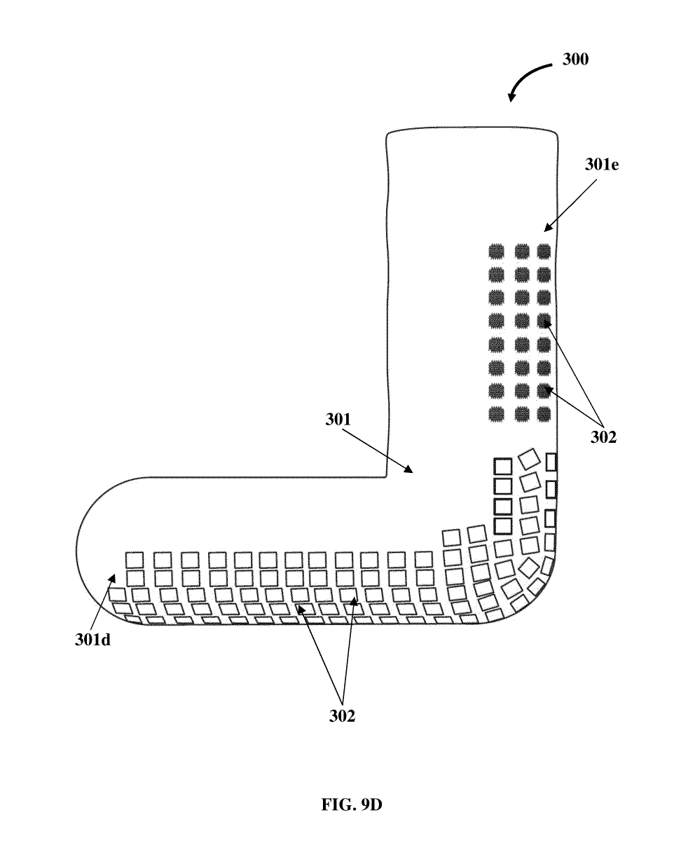

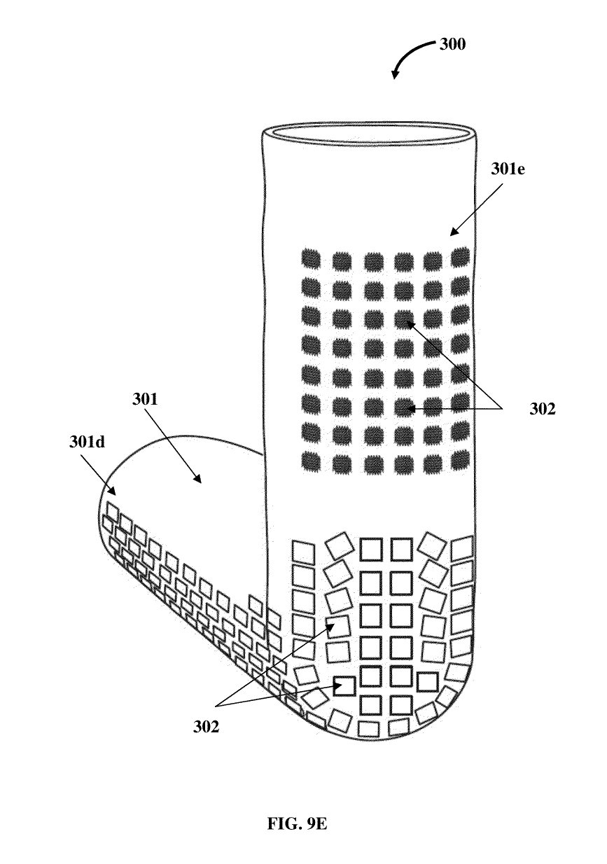

FIG. 9A exemplarily illustrates heat pressing of a non-slip material 302 configured into square shapes in contact with each other on a lower part 301d of a fabric structure 301 using a heat press 801. A fabric structure 301 comprising, for example, natural threads and/or synthetic threads, that defines an inner surface 301a and an outer surface 301b, for example, in the form of a sock is created. In an embodiment, the fabric structure 301 comprising, for example, natural threads and/or synthetic threads is positioned over a sock form 805. In this embodiment, the creation of continuous non-slip layers 303a and 303b on the inner surface 301a and the outer surface 301b of the created fabric structure 301 comprises configuring the sheet of non-slip material 302 into one or more shapes, for example, square shapes such as Clarino® blocks and applying the configured non-slip material 302 in those shapes continuously in contact with each other on a selective continuous portion, for example, the inner surface 301a and the outer surface 301b of the lower part 301d of the created fabric structure 301 as exemplarily illustrated in FIG. 9B. In this embodiment, the application of the configured non-slip material 302 on the lower part 301d of the fabric structure 301 is performed, for example, by heat pressing for transferring the configured non-slip material 302 to the inner surface 301a and the outer surface 301b of the lower part 301d of the fabric structure 301.

In an embodiment, the non-slip material 302 is cut, for example, by laser cutting, die cutting, rotary cutting, etc., for example, into square shapes to a required specification and aligned on a transfer material 802, for example, made of paper. The configured non-slip material 302, for example, Clarino® blocks are positioned in contact with each other and attached to the transfer material 802 using a temporary adhesive 803 provided on the transfer material 802 to create continuous non-slip layers 303a and 303b on the inner surface 301a and the outer surface 301b of the lower part 301d of the fabric structure 301 respectively. The temporary adhesive 803 holds the configured non-slip material 302 in place until the configured non-slip material 302 is heat pressed onto the fabric structure 301 by using the heat press 801. The transfer material 802 that carries the configured non-slip material 302 is positioned above and below the fabric structure 301 as exemplarily illustrated in FIG. 9A, with the configured non-slip material 302 facing the outer surface 301b and the inner surface 301a of the fabric structure 301 respectively. Surfaces 302b and 302a of the configured non-slip material 302 are coated with a sealing element, for example, a heat seal adhesive 804 such as Bemis 3218, a fabric glue, a polyurethane heat seal, etc.

The transfer material 802 with the configured non-slip material 302 positioned below the fabric structure 301 rests on the sock form 805. The configured non-slip material 302 is then applied on the inner surface 301a and the outer surface 301b of the lower part 301d of the fabric structure 301 by heat pressing as exemplarily illustrated in FIG. 9A and as disclosed in the detailed description of FIG. 8. The heat seal adhesive 804 attaches the configured non-slip material 302 to the inner surface 301a and the outer surface 301b of the fabric structure 301. After the configured non-slip material 302 is transferred to the inner surface 301a and the outer surface 301b of the lower part 301d of the fabric structure 301, the transfer material 802 is peeled off from the fabric structure 301, while retaining the configured non-slip material 302 on the fabric structure 301.

FIG. 9B exemplarily illustrates a perspective view of the continuous non-slip layered garment 300, showing the non-slip material 302 configured in square shapes heat pressed on the lower part 301d of the fabric structure 301 as disclosed in the detailed description of FIG. 9A. When a user wears the continuous non-slip layered garment 300 in the form of a sock on a foot along with a shoe, the attached non-slip material 302 on the inner surface 301a and the outer surface 301b of the lower part 301d of the fabric structure 301 of the continuous non-slip layered garment 300 adheres to the user contact surface, that is, the skin on the bottom of the user's foot, and the external contact surface, that is, the inside surface of the shoe respectively, provides grip between the user contact surface and the fabric structure 301, and provides grip between the fabric structure 301 and the external contact surface.

FIG. 9C exemplarily illustrates heat pressing of a non-slip material 302 configured into square shapes spaced apart from each other on selective continuous portions of the inner surface 301a and the outer surface 301b of the fabric structure 301 in a pattern. In an embodiment, the creation of continuous non-slip layers 303a and 303b on the inner surface 301a and the outer surface 301b of the created fabric structure 301 respectively, comprises configuring the non-slip material 302 into one or more shapes, for example, square shapes, and applying the configured non-slip material 302 in one or more shapes spaced apart from each other on the selective continuous portions of the inner surface 301a and the outer surface 301b of the created fabric structure 301, for example, by heat pressing as exemplarily illustrated in FIG. 9C. In another embodiment, the configured non-slip material 302 in one or more shapes is applied on selective non-continuous portions of the inner surface 301a and the outer surface 301b of the created fabric structure 301, for example, by heat pressing. By performing heat pressing as disclosed in the detailed description of FIG. 8 and FIG. 9A, a sealing element, for example, a heat seal adhesive 804 attaches the configured non-slip material 302 to the inner surface 301a and the outer surface 301b of the fabric structure 301. The created fabric structure 301 with the applied non-slip material 302 on the selective continuous portions of the inner surface 301a and the outer surface 301b of the created fabric structure 301 form the continuous non-slip layered garment 300 exemplarily illustrated in FIGS. 9D-9E. The attached non-slip material 302 on the inner surface 301a and the outer surface 301b of the fabric structure 301 adheres to the user contact surface and the external contact surface respectively, provides grip between the user contact surface and the fabric structure 301, and provides grip between the fabric structure 301 and the external contact surface.

In another embodiment, the application of the non-slip material 302 on selective continuous portions or, in an embodiment, on selective non-continuous portions of the inner surface 301a and the outer surface 301b of the created fabric structure 301 is performed, for example, by one or more of heat pressing, spraying, pouring, painting, screen printing, and attaching the non-slip material 302 on the selective continuous portions or the selective non-continuous portions of the inner surface 301a and the outer surface 301b of the created fabric structure 301 in one or more of multiple patterns as exemplarily illustrated in FIGS. 9D-9E. In an embodiment, the application of the non-slip material 302 on the selective continuous portions or substantially whole portions, for example, the inner surface 301a and the outer surface 301b of an upper part 301c and a lower part 301d of the created fabric structure 301 comprises creating a design frame (not shown) comprising one or more patterned openings (not shown); positioning the created design frame on the selective continuous portions or substantially whole portions of each of the inner surface 301a and the outer surface 301b of the created fabric structure 301; and applying the non-slip material 302 on the design frame on the selective continuous portions or substantially whole portions of each of the inner surface 301a and the outer surface 301b of the created fabric structure 301, where the non-slip material 302 passes through the patterned openings of the design frame and adheres to the selective continuous portions or the substantially whole portions of each of the inner surface 301a and the outer surface 301b of the created fabric structure 301 in a pattern defined by the patterned openings of the design frame.

FIG. 9D exemplarily illustrates a right side elevation view of a continuous non-slip layered garment 300, showing the non-slip material 302 heat pressed on selective continuous portions, for example, the inner surface 301a and the outer surface 301b of an upper part 301e and a lower part 301d of the fabric structure 301 in a pattern. FIG. 9E exemplarily illustrates a rear perspective view of the continuous non-slip layered garment 300 shown in FIG. 9D. When a user wears the continuous non-slip layered garment 300 in the form of a sock on a foot along with a shoe, the non-slip material 302 applied on the inner surface 301a and the outer surface 301b of the upper part 301e and the lower part 301d of the fabric structure 301 of the continuous non-slip layered garment 300 in the pattern exemplarily illustrated in FIG. 9D-9E, adheres and provides grip to the user contact surface, for example, the upper part of the user's leg, the ankle, and the bottom of the user's foot from the heel to the toes, and the external contact surface, for example, the corresponding inside surfaces of the user's shoe.

FIG. 10 exemplarily illustrates pouring of a non-slip material 302 on an entire or substantially entire inner surface 301a of a fabric structure 301 and on an entire or substantially entire outer surface 301b of the fabric structure 301. The fabric structure 301 is configured to conform to a user's body part, for example, the user's foot to construct a garment, for example, a sock. The threads of the fabric structure 301 are knitted, for example, using the circular knitting machine 511 exemplarily illustrated in FIG. 5A, to construct the sock. The configured fabric structure 301 is positioned over a framework, for example, a sock form 805. In this example, the application of the non-slip material 302 to the whole portions or the entire or substantially the entire outer surface 301b of the configured fabric structure 301 is performed by pouring the non-slip material 302 on the outer surface 301b of the configured fabric structure 301 through a nozzle 1001. After pouring the non-slip material 302 through the nozzle 1001, the non-slip material 302 adheres to the entire or substantially the entire outer surface 301b of the configured fabric structure 301. The non-slip material 302 then solidifies on the configured fabric structure 301 as exemplarily illustrated in FIG. 12A.

In an embodiment, the non-slip material 302 is also applied to the whole portions or the entire or substantially the entire inner surface 301a of the configured fabric structure 301 by pouring the non-slip material 302 on the entire or substantially the entire inner surface 301a of the configured fabric structure 301. After pouring the non-slip material 302 on the entire or substantially the entire outer surface 301b of the configured fabric structure 301, the configured fabric structure 301 is flipped inside out and repositioned over the sock form 805 prior to pouring the non-slip material 302 on the entire or substantially the entire inner surface 301a of the configured fabric structure 301. The poured non-slip material 302 adheres to the entire or substantially the entire inner surface 301a of the configured fabric structure 301.

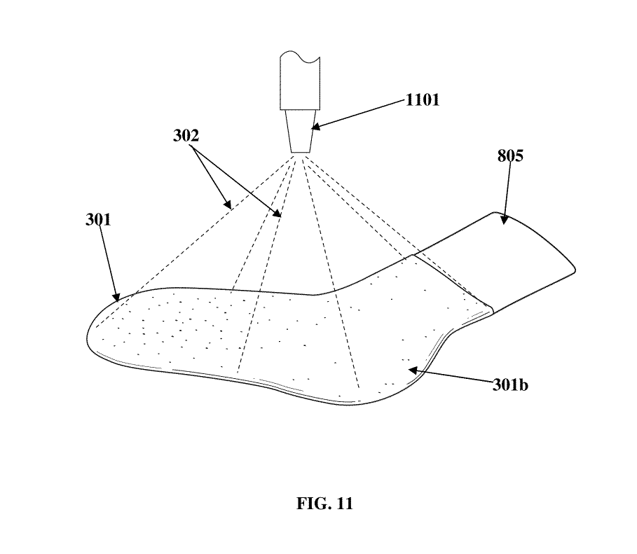

FIG. 11 exemplarily illustrates spraying of a non-slip material 302 on an entire or substantially entire inner surface 301a of a fabric structure 301 and on an entire or substantially entire outer surface 301b of the fabric structure 301. The fabric structure 301 is configured to conform to a user's body part, for example, the user's foot to construct a garment, for example, a sock. The threads of the fabric structure 301 are knitted, for example, using the circular knitting machine 511 exemplarily illustrated in FIG. 5A, to construct the sock. The configured fabric structure 301 is positioned over a framework, for example, a sock form 805. In this example, the application of the non-slip material 302 to the whole portions or the entire or substantially the entire outer surface 301b of the configured fabric structure 301 is performed by spraying the non-slip material 302 on the entire or substantially the entire outer surface 301b of the configured fabric structure 301 through a nozzle 1101. After spraying the non-slip material 302 through the nozzle 1101, the non-slip material 302 adheres to the entire or substantially the entire outer surface 301b of the configured fabric structure 301. The non-slip material 302 then solidifies on the configured fabric structure 301 as exemplarily illustrated in FIG. 12A.

In an embodiment, the non-slip material 302 is also applied to the whole portions or the entire or substantially the entire the inner surface 301a of the configured fabric structure 301 by spraying the non-slip material 302 on the entire or substantially the entire inner surface 301a of the configured fabric structure 301. After spraying the non-slip material 302 on the entire or substantially the entire outer surface 301b of the configured fabric structure 301, the configured fabric structure 301 is flipped inside out and repositioned over the sock form 805 prior to spraying the non-slip material 302 on the entire or substantially the entire inner surface 301a of the configured fabric structure 301. The sprayed non-slip material 302 adheres to the inner surface 301a of the configured fabric structure 301.

FIG. 12A exemplarily illustrates a perspective view of a continuous non-slip layered garment 300 positioned on a sock form 805, where the non-slip material 302 is either poured or sprayed onto the fabric structure 301 as exemplarily illustrated in FIGS. 10-11. After the non-slip material 302 is either poured or sprayed onto the fabric structure 301, the non-slip material 302 solidifies over the fabric structure 301 to form the continuous non-slip layered garment 300.

FIG. 12B exemplarily illustrates a sectional view of the continuous non-slip layered garment 300 positioned on a sock form 805, taken along a sectional line XX in FIG. 12A. The continuous non-slip layered garment 300 comprises a fabric structure 301, a first continuous non-slip layer 303a, and a second continuous non-slip layer 303b. The fabric structure 301 conforms to a body part, for example, the user's foot. The fabric structure 301 comprises an inner surface 301a and an outer surface 301b. The first continuous non-slip layer 303a is created on an entire or substantially entire inner surface 301a of the fabric structure 301 by application of a non-slip material 302 on the entire or substantially the entire inner surface 301a of the fabric structure 301, for example, by heat pressing, spraying, pouring, etc., of the non-slip material 302 on the entire or substantially the entire inner surface 301a of the fabric structure 301. The second continuous non-slip layer 303b is created on an entire or substantially entire outer surface 301b of the fabric structure 301 by application of the non-slip material 302 on the entire or substantially the entire outer surface 301b of the fabric structure 301, for example, by heat pressing, spraying, pouring, etc., of the non-slip material 302 on the entire or substantially the entire outer surface 301b of the fabric structure 301. The first continuous non-slip layer 303a and the second continuous non-slip layer 303b provide simultaneous gripping contact between the entire or substantially entire inner surface 301a of the created fabric structure 301 and a user contact surface, for example, the skin of a user's foot wearing the continuous non-slip layered garment 300, and between the entire or substantially the entire outer surface 301b of the created fabric structure 301 and an external contact surface 304, for example, the inside surface of the user's shoe 305 exemplarily illustrated in FIG. 3E.

FIG. 12C exemplarily illustrates a cutaway view of the continuous non-slip layered garment 300 positioned over a sock form 805, showing three layers of the continuous non-slip layered garment 300. FIG. 12D exemplarily illustrates an enlarged view of a cut portion marked P in FIG. 12C, showing the three layers of the continuous non-slip layered garment 300. The three layers of the continuous non-slip layered garment 300 are the fabric structure 301, the first continuous non-slip layer 303a created in the inner surface 301a of the fabric structure 301, and the second continuous non-slip layer 303b created in the outer surface 301b of the fabric structure 301.

FIGS. 13A-13C exemplarily illustrate attaching a continuous non-slip layered patch 1302 to a lower part 1301a of a garment 1301. In an embodiment, the fabric structure 301 with the applied non-slip material 302 exemplarily illustrated in FIG. 8, is configured as a patch 1302 herein also referred to as the “continuous non-slip layered patch”. The patch 1302 is attached or bonded to one or more sections of a garment 1301 wearable by a user. In an embodiment, the patch 1302 is, for example, made of a non-slip material 302, for example, a thermoplastic elastomer, a polyvinyl chloride, natural latex, synthetic latex, synthetic suede, suede leather, synthetic leather, other leathers, etc., instead of being made of a fabric structure 301 to which the non-slip material 302 is coated. As exemplarily illustrated in FIGS. 13A-13C, the patch 1302 having an inner non-slip layer 303a and an outer non-slip layer 303b is attached, for example, by sewing the patch 1302 to one or more sections of the garment 1301 for providing grip between a user contact surface and the patch 1302, and for providing grip between the patch 1302 and an external contact surface. The attached patch 1302 contacts both the user contact surface and the external contact surface simultaneously.

As exemplarily illustrated in FIG. 13B, an opening 1301b is defined in the garment 1301. The patch 1302 having the non-slip layers 303a and 303b exemplarily illustrated in FIG. 13A, is then targeted towards the opening 1301b, and sewn along the edge 1301c of the opening 1301b exemplarily illustrated in FIG. 13B, for example, using a sewing needle 1303 to cover the opening 1301b in the garment 1301 as exemplarily illustrated in FIG. 13C, thereby making a continuous non-slip layered garment 1300 exemplarily illustrated in FIG. 13D, that is, a continuous non-slip layered sock. As exemplarily illustrated in FIG. 13D, the sewn patch 1302 having the non-slip layers 303a and 303b on a section, for example, the lower part of the continuous non-slip layered garment 1300 provides a grip, for example, to the bottom of the user's foot between the bottom of the user's foot and the patch 1302 and simultaneously provides grip, that is, traction between the patch 1302 and a shoe worn by the user. FIG. 13D exemplarily illustrates a perspective view showing the continuous non-slip layered garment 1300 made by attaching the continuous non-slip layered patch 1302 to the lower part 1301a of the garment 1301.

FIG. 13E exemplarily illustrates a sectional view of the continuous non-slip layered garment 1300 taken along a sectional line YY in FIG. 13D, showing the continuous non-slip layered patch 1302. The continuous non-slip layered patch 1302 comprises three layers, that is, the fabric structure 301, the first continuous non-slip layer 303a on the inner surface 301a of the fabric structure 301, and the second continuous non-slip layer 303b on the outer surface 301b of the fabric structure 301. The continuous non-slip layers 303 provide grip between a user contact surface and the continuous non-slip layered patch 1302, and provide grip between the continuous non-slip layered patch 1302 and an external contact surface.

FIGS. 14A-14C exemplarily illustrate attaching a continuous non-slip layered patch 1401 to an upper part 1402a of a garment 1402, for example, a sock. As exemplarily illustrated in FIG. 14A, the continuous non-slip layered patch 1401 having an inner non-slip layer 303a and an outer non-slip layer 303b is attached to one or more sections, for example, 1402a of the garment 1402, for example, by sewing the continuous non-slip layered patch 1401 to one or more sections, for example, 1402a of the garment 1402 for providing grip between a user contact surface and the continuous non-slip layered patch 1401, and for providing grip between the continuous non-slip layered patch 1401 and an external contact surface. The attached continuous non-slip layered patch 1401 contacts both the user contact surface and the external contact surface simultaneously. As exemplarily illustrated in FIG. 14A, an opening 1402b is defined in the garment 1402. As exemplarily illustrated in FIGS. 14A-14C, the continuous non-slip layered patch 1401 having the non-slip layers 303a and 303b is targeted towards the opening 1402b and sewn along the edge 1402c of the opening 1402b, for example, using a sewing needle 1303, to cover the opening 1402b in the garment 1402, thereby making a continuous non-slip layered garment 1400, for example, a continuous non-slip layered sock.

FIG. 14D exemplarily illustrates a perspective view of a continuous non-slip layered garment 1400 made by attaching the continuous non-slip layered patch 1401 to the upper part 1402a of the garment 1402. The continuous non-slip layered garment 1400 is formed by stitching the continuous non-slip layered patch 1401 to the upper part 1402a of the garment 1402. As exemplarily illustrated in FIGS. 14A-14C, the sewn continuous non-slip layered patch 1401 having the non-slip layers 303a and 303b on a section, for example, 1402a of the garment 1402 provides a grip, for example, above the ankle of the user's foot.

FIG. 14E exemplarily illustrates a sectional view of the continuous non-slip layered garment 1400 taken along a sectional line ZZ in FIG. 14D, after stitching the patch 1401 to an upper part 1402a of a garment 1402. The continuous non-slip layered patch 1401 comprises three layers, that is, the fabric structure 301, the first continuous non-slip layer 303a on the inner surface 301a of the fabric structure 301, and the second continuous non-slip layer 303b on the outer surface 301b of the fabric structure 301. The continuous non-slip layers 303 provide a grip between a user contact surface and the continuous non-slip layered patch 1401, and provide grip between the continuous non-slip layered patch 1401 and an external contact surface.

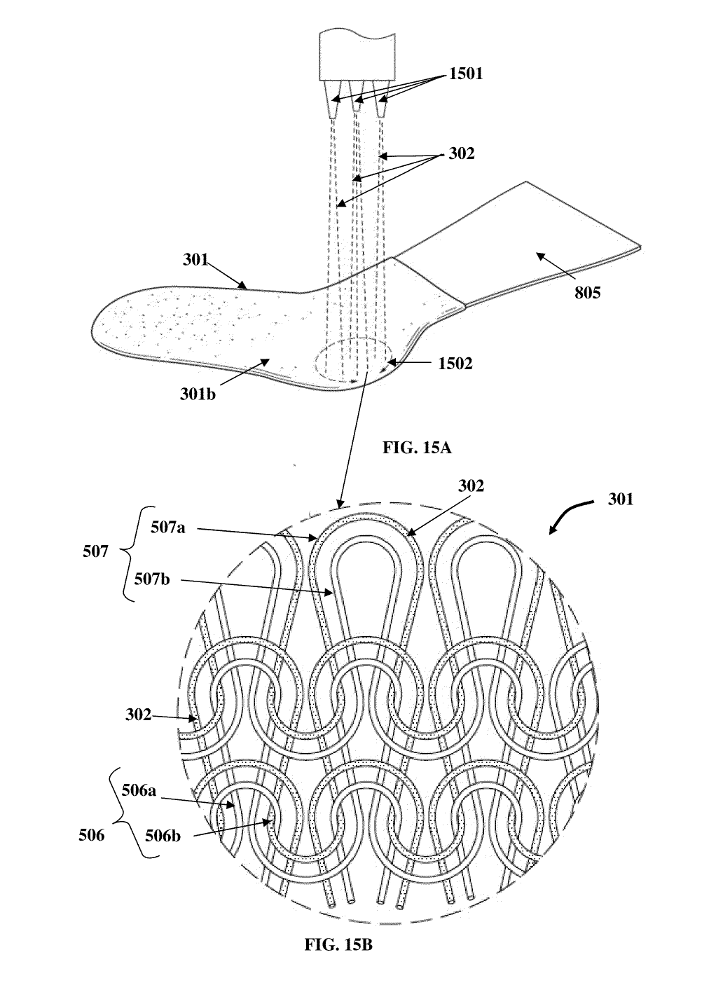

FIG. 15A exemplarily illustrates spraying of a non-slip material 302 on a fabric structure 301 configured to conform to a user's body part to make a continuous non-slip layered garment 300 as exemplarily illustrated in FIG. 12A. The fabric structure 301 configured, for example, as a sock is positioned on a sock form 805. As exemplarily illustrated in FIG. 15A, the non-slip material 302, for example, in a liquid form is sprayed through nozzles 1501 on the outer surface 301b of the configured fabric structure 301. After spraying the non-slip material 302 on the outer surface 301b of the configured fabric structure 301, the configured fabric structure 301 is flipped inside out and repositioned over the sock form 805 prior to spraying the non-slip material 302 on the inner surface 301a of the configured fabric structure 301.

FIG. 15B exemplarily illustrates an enlarged view of a sprayed portion 1502 of the fabric structure 301 shown in FIG. 15A. By spraying, the non-slip material 302 is applied on the first non-slip thread 506a and/or the first supplementary thread 506b in the first pair 506 that defines the inner surface 301a of the fabric structure 301, and on the second non-slip thread 507a and/or the second supplementary thread 507b in the second pair 507 that defines the outer surface 301b of the fabric structure 301, for example, by spraying the non-slip material 302 on the inner surface 301a and/or the outer surface 301b of the fabric structure 301. In an embodiment, the non-slip material 302 is applied on the first non-slip thread 506a and/or the first supplementary thread 506b in the first pair 506 that defines the inner surface 301a of the fabric structure 301, and on the second non-slip thread 507a and/or the second supplementary thread 507b in the second pair 507 that defines the outer surface 301b of the fabric structure 301, for example, by spraying the non-slip material 302 on selected continuous portions or selective non-continuous portions of the inner surface 301a and the outer surface 301b of the fabric structure 301 in one or more of multiple patterns. As exemplarily illustrated in FIG. 15B, the non-slip material 302 adheres to the first supplementary thread 506b in the first pair 506 and to the second non-slip thread 507a in the second pair 507. The non-slip material 302 on the inner surface 301a defined by the first pair 506 and the outer surface 301b defined by the second pair 507 adheres to the user contact surface and the external contact surface respectively, for providing enhanced grip between the user contact surface and the fabric structure 301, and between the fabric structure 301 and the external contact surface respectively.

In an embodiment, the non-slip material 302 is applied on the first non-slip thread 506a and/or the first supplementary thread 506b in the first pair 506 that defines the inner surface 301a of the fabric structure 301, and on the second non-slip thread 507a and/or the second supplementary thread 507b in the second pair 507 that defines the outer surface 301b of the fabric structure 301 exemplarily illustrated in FIG. 15B, for example, by one or more of painting, pouring, screen printing, etc., the non-slip material 302 on selective continuous portions or selective non-continuous portions of the inner surface 301a and the outer surface 301b of the fabric structure 301 in one or more of multiple patterns.

The foregoing examples have been provided merely for the purpose of explanation and are in no way to be construed as limiting of the method disclosed herein. While the method disclosed herein has been described with reference to various embodiments, it is understood that the words, which have been used herein, are words of description and illustration, rather than words of limitation. Further, although the method has been described herein with reference to particular means, materials, and embodiments, the method disclosed herein is not intended to be limited to the particulars disclosed herein; rather, the method extends to all functionally equivalent structures, methods and uses, such as are within the scope of the appended claims. Those skilled in the art, having the benefit of the teachings of this specification, may effect numerous modifications thereto and changes may be made without departing from the scope and spirit of the method disclosed herein in their aspects.

I claim:

1. A method for making a continuous non-slip layered garment, said method comprising:
creating a fabric structure configured to conform to a body part, said fabric structure comprising an inner surface and an outer surface, wherein said inner surface is proximal to a user contact surface and distal to an external contact surface, and wherein said outer surface is proximal to said external contact surface and distal to said user contact surface; and
creating a first continuous non-slip layer on one of an entire said inner surface and a substantially entire said inner surface of said created fabric structure, and a second continuous non-slip layer on one of an entire said outer surface and a substantially entire said outer surface of said created fabric structure to make said continuous non-slip layered garment, by applying a non-slip material on said one of said entire said inner surface and said substantially entire said inner surface of said created fabric structure and on said one of said entire said outer surface and said substantially entire said outer surface of said created fabric structure, wherein said first continuous non-slip layer created on said one of said entire said inner surface and said substantially entire said inner surface of said created fabric structure and said second continuous non-slip layer created on said one of said entire said outer surface and said substantially entire said outer surface of said created fabric structure are configured to provide simultaneous gripping contact between said one of said entire said inner surface and said substantially entire said inner surface of said created fabric structure and said user contact surface, and between said one of said entire said outer surface and said substantially entire said outer surface of said created fabric structure and said external contact surface.

2. The method of claim 1, wherein said application of said non-slip material on said one of said entire said inner surface and said substantially entire said inner surface of said created fabric structure and on said one of said entire said outer surface and said substantially entire said outer surface of said created fabric structure is performed by one or more of heat pressing, spraying, pouring, painting, screen printing, and attaching said non-slip material on said one of said entire said inner surface and said substantially entire said inner surface of said created fabric structure and said one of said entire said outer surface and said substantially entire said outer surface of said created fabric structure.

3. The method of claim 1, wherein said creation of said fabric structure comprises:
providing multiple non-slip threads and supplementary threads;
separating said non-slip threads into a first non-slip thread and a second non-slip thread; and
winding said first non-slip thread, said second non-slip thread, a first supplementary thread, and a second supplementary thread onto a first spool, a second spool, a third spool, and a fourth spool respectively.

4. The method of claim 3, wherein said creation of said fabric structure further comprises:
grouping said first non-slip thread and said first supplementary thread into a first pair;
grouping said second non-slip thread and said second supplementary thread into a second pair; and
knitting said first pair with said second pair to form said fabric structure, said first pair defining said inner surface of said fabric structure, said second pair defining said outer surface of said fabric structure, wherein said first non-slip thread of said first pair is exposed on said inner surface of said fabric structure, and wherein said first non-slip thread of said first pair is not exposed on said outer surface of said fabric structure, and wherein said second non-slip thread of said second pair is exposed on said outer surface of said fabric structure, and wherein said second non-slip thread of said second pair is not exposed on said inner surface of said fabric structure.

5. The method of claim 4, wherein said non-slip material is applied on one or more of said first non-slip thread and said first supplementary thread in said first pair that defines said inner surface of said fabric structure, and on one or more of said second non-slip thread and said second supplementary thread in said second pair that defines said outer surface of said fabric structure, and wherein said non-slip material adheres to said one or more of said first non-slip thread and said first supplementary thread in said first pair and to said one or more of said second non-slip thread and said second supplementary thread in said second pair, and wherein said non-slip material on said inner surface defined by said first pair and said outer surface defined by said second pair adheres to said user contact surface and said external contact surface respectively for providing enhanced grip between said user contact surface and said fabric structure, and between said fabric structure and said external contact surface respectively.

6. The method of claim 3, wherein said creation of said fabric structure further comprises:
feeding said first non-slip thread, said second non-slip thread, said first supplementary thread, and said second supplementary thread into a first finger tube, a second finger tube, a third finger tube, and a fourth finger tube respectively;
knitting said first supplementary thread retrieved from said third finger tube and said second supplementary thread retrieved from said fourth finger tube using a plating technique, wherein said first supplementary thread is exposed on said inner surface of said fabric structure, and wherein said second supplementary thread is exposed on said outer surface of said fabric structure; and
knitting said first non-slip thread retrieved from said first finger tube and said second non-slip thread retrieved from said second finger tube using a plating technique, wherein said first non-slip thread is exposed on said inner surface of said fabric structure, and wherein said first non-slip thread is not exposed on said outer surface of said fabric structure, and wherein said second non-slip thread is exposed on said outer surface of said fabric structure, and wherein said second non-slip thread is not exposed on said inner surface of said fabric structure, and wherein a first pair of said first non-slip thread and said first supplementary thread defines said inner surface of said fabric structure, and a second pair of said second non-slip thread and said second supplementary thread defines said outer surface of said fabric structure.

7. The method of claim 1, wherein said creation of said fabric structure comprises knitting non-slip threads to define said entire said inner surface and said entire said outer surface of said fabric structure.

8. The method of claim 1, wherein said created fabric structure with said applied non-slip material is configured as a patch, wherein said patch is one of attached and bonded to one or more sections of a garment wearable by a user for providing grip between said user contact surface and said patch, and for providing grip between said patch and said external contact surface.

9. A method for making a continuous non-slip layered garment, said method comprising:
creating a fabric structure configured to conform to a body part, said fabric structure comprising an inner surface and an outer surface, wherein said inner surface is proximal to a user contact surface and distal to an external contact surface, and wherein said outer surface is proximal to said external contact surface and distal to said user contact surface; and
creating continuous non-slip layers on said inner surface and said outer surface of said created fabric structure to make said continuous non-slip layered garment, by applying a non-slip material on one of selective continuous portions and whole portions of said inner surface and said outer surface of said created fabric structure, wherein said continuous non-slip layers created on said inner surface and said outer surface of said created fabric structure are configured to provide simultaneous gripping contact between said inner surface of said created fabric structure and said user contact surface, and between said outer surface of said created fabric structure and said external contact surface.

10. The method of claim 9, wherein said application of said non-slip material on said one of said selective continuous portions and said whole portions of said inner surface and said outer surface of said created fabric structure is performed by one or more of heat pressing, spraying, pouring, painting, screen printing, and attaching said non-slip material on said one of said selective continuous portions and said whole portions of said inner surface and said outer surface of said created fabric structure.

11. The method of claim 9, wherein said application of said non-slip material on one of said selective continuous portions and selective non-continuous portions of said inner surface and said outer surface of said created fabric structure is performed by one or more of heat pressing, spraying, pouring, painting, screen printing, and attaching said non-slip material on said one of said selective continuous portions and said selective non-continuous portions of said inner surface and said outer surface of said created fabric structure in one or more of a plurality of patterns.

12. The method of claim 9, wherein said creation of said continuous non-slip layers on said inner surface and said outer surface of said created fabric structure comprises:
configuring said non-slip material into one or more of a plurality of shapes; and
applying said configured non-slip material in said one or more of said shapes on one of said selective continuous portions, selective non-continuous portions, and said whole portions of said inner surface and said outer surface of said created fabric structure.

13. The method of claim 9, wherein said creation of said fabric structure comprises:
providing multiple non-slip threads and supplementary threads;
separating said non-slip threads into a first non-slip thread and a second non-slip thread; and
winding said first non-slip thread, said second non-slip thread, a first supplementary thread, and a second supplementary thread onto a first spool, a second spool, a third spool, and a fourth spool respectively.

14. The method of claim 13, wherein said creation of said fabric structure further comprises:
grouping said first non-slip thread and said first supplementary thread into a first pair;
grouping said second non-slip thread and said second supplementary thread into a second pair; and
knitting said first pair with said second pair to form said fabric structure, said first pair defining said inner surface of said fabric structure, said second pair defining said outer surface of said fabric structure, wherein said first non-slip thread of said first pair is exposed on said inner surface of said fabric structure, and wherein said first non-slip thread of said first pair is not exposed on said outer surface of said fabric structure, and wherein said second non-slip thread of said second pair is exposed on said outer surface of said fabric structure, and wherein said second non-slip thread of said second pair is not exposed on said inner surface of said fabric structure.

15. The method of claim 14, wherein said non-slip material is applied on one or more of said first non-slip thread and said first supplementary thread in said first pair that defines said inner surface of said fabric structure, and on one or more of said second non-slip thread and said second supplementary thread in said second pair that defines said outer surface of said fabric structure, and wherein said non-slip material adheres to said one or more of said first non-slip thread and said first supplementary thread in said first pair and to said one or more of said second non-slip thread and said second supplementary thread in said second pair, and wherein said non-slip material on said inner surface defined by said first pair and said outer surface defined by said second pair adheres to said user contact surface and said external contact surface respectively for providing enhanced grip between said user contact surface and said fabric structure, and between said fabric structure and said external contact surface respectively.

16. The method of claim 13, further comprising:
feeding said first non-slip thread and said first supplementary thread from said first spool and said third spool respectively into a first finger tube; and
feeding said second non-slip thread and said second supplementary thread from said second spool and said fourth spool respectively into a second finger tube.

17. The method of claim 13, wherein said creation of said fabric structure further comprises:
feeding said first non-slip thread, said second non-slip thread, said first supplementary thread, and said second supplementary thread into a first finger tube, a second finger tube, a third finger tube, and a fourth finger tube respectively;
knitting said first supplementary thread retrieved from said third finger tube and said second supplementary thread retrieved from said fourth finger tube using a plating technique, wherein said first supplementary thread is exposed on said inner surface of said fabric structure, and wherein said second supplementary thread is exposed on said outer surface of said fabric structure; and
knitting said first non-slip thread retrieved from said first finger tube and said second non-slip thread retrieved from said second finger tube using a plating technique, wherein said first non-slip thread is exposed on said inner surface of said fabric structure, and wherein said first non-slip thread is not exposed on said outer surface of said fabric structure, and wherein said second non-slip thread is exposed on said outer surface of said fabric structure, and wherein said second non-slip thread is not exposed on said inner surface of said fabric structure, and wherein a first pair of said first non-slip thread and said first supplementary thread defines said inner surface of said fabric structure, and a second pair of said second non-slip thread and said second supplementary thread defines said outer surface of said fabric structure.

18. The method of claim 9, wherein said creation of said fabric structure comprises knitting non-slip threads to define an entire said inner surface and an entire said outer surface of said fabric structure.

19. The method of claim 9, wherein said created fabric structure with said applied non-slip material is configured as a patch, wherein said patch is one of attached and bonded to one or more sections of a garment wearable by a user for providing grip between said user contact surface and said patch, and for providing grip between said patch and said external contact surface.

20. A continuous non-slip layered garment comprising:
a fabric structure configured to conform to a body part, said fabric structure comprising an inner surface and an outer surface, wherein said inner surface is proximal to a user contact surface and distal to an external contact surface, and wherein said outer surface is proximal to said external contact surface and distal to said user contact surface;
a first continuous non-slip layer created on one of an entire said inner surface and a substantially entire said inner surface of said fabric structure by application of a non-slip material on said one of said entire said inner surface and said substantially entire said inner surface of said fabric structure; and
a second continuous non-slip layer created on one of an entire said outer surface and a substantially entire said outer surface of said fabric structure by application of said non-slip material on said one of said entire said outer surface and said substantially entire said outer surface of said fabric structure, wherein said first continuous non-slip layer and said second continuous non-slip layer are configured to provide simultaneous gripping contact between said one of said entire said inner surface and said substantially entire said inner surface of said created fabric structure and said user contact surface, and between said one of said entire said outer surface and said substantially entire said outer surface of said created fabric structure and said external contact surface.
